(19) United States
(12) Patent Application Publication
(10) Pub. No.: US 2026/0056127 A1
(43) Pub. Date: Feb. 26, 2026

(54) METHODS, SYSTEMS, AND COMPUTER READABLE MEDIA FOR FLUORESCENCE TOMOGRAPHY IMAGE ACQUISITION AND RECONSTRUCTION USING LINE SOURCES

(71) Applicant: Revvity Health Sciences, Inc., Waltham, MA (US)

(72) Inventors: Michael Joseph Massey, Waltham, MA (US); Jorge Ripoll, Waltham, MA (US)

(21) Appl. No.: 19/307,619

(22) Filed: Aug. 22, 2025

Related U.S. Application Data
(60) Provisional application No. 63/686,032, filed on Aug. 22, 2024.

(51) Int. Cl. G01N 21/64

(52) U.S. Cl. CPC G01N 21/6456; G01N 21/6454; G01N 2201/0625; G01N 2201/0636

(57) ABSTRACT

A method for fluorescence imaging tomography includes placing at least one subject on an imaging platform. The method further includes controlling light emanating from a light source to project an illumination pattern comprising at least one line onto the at least one subject. The method further includes acquiring, at a plurality of locations on a detector, light intensity values at excitation wavelengths resulting from the projecting of the illumination pattern onto the at least one subject. The method further includes acquiring, at the plurality of locations on the detector, light intensity values at emission wavelengths resulting from a fluorescence response of fluorescent sources within the at least one subject to the projecting of the illumination pattern the at least one subject. The method further includes generating an image of the fluorescent sources within the at least one subject based on the acquired light intensity values and outputting the image.

### PRIORITY CLAIM

This application claims the priority benefit of U.S. Provisional Patent Application Ser. No. 63/686,032 filed Aug. 22, 2024, the disclosure of which is incorporated herein by reference in its entirety.

### TECHNICAL FIELD

The subject matter described herein relates to fluorescence imaging tomography. More particularly, the subject matter described herein relates to methods, systems, and computer readable media for fluorescence tomography image acquisition and reconstruction using line sources.

### BACKGROUND

Fluorescence imaging tomography involves scanning a light beam from a light source over a subject being imaged, detecting light emitted from fluorophores in the subject at a different wavelength from the emission wavelength, and reconstructing an image of the fluorophore concentration in the subject. One goal of techniques for fluorescence imaging tomography in diffuse media, such as animal or human tissue, is to reduce data acquisition time while maintaining the same quantitative resolution and accuracy as traditional fluorescence tomography measurements.

Traditional fluorescence imaging tomography involves scanning light from a point source over a subject being imaged, recording the emitted light, and reconstructing the fluorescence image from the emitted light. While using a point source may result in accurate image reconstruction, scanning and reconstructing the image from a point light source is time and processor intensive.

Accordingly, in light of these and other difficulties, there exists a need for improved methods, systems, and computer readable media for fluorescence imaging tomography with reduced data acquisition and image reconstruction time while achieving desired accuracy and resolution levels.

### SUMMARY

A method for fluorescence imaging tomography includes placing at least one subject on an imaging platform. The method further includes controlling light emanating from a light source to project an illumination pattern comprising at least one line onto the at least one subject. The method further includes acquiring, at a plurality of locations on a detector, light intensity values at excitation wavelengths resulting from the projecting of the illumination pattern onto the at least one subject. The method further includes acquiring, at the plurality of locations on the detector, light intensity values at emission wavelengths resulting from a fluorescence response of fluorescent sources within the at least one subject to the projecting of the illumination pattern onto the at least one subject. The method further includes generating an image of the fluorescent sources within the at least one subject based on the acquired light intensity values. The method further includes outputting the image.

According to another aspect of the subject matter described herein, controlling the light emanating from the light source to project the illumination pattern onto the at least one subject includes controlling the light source to project the illumination pattern onto the at least one subject for illuminating the at least one subject from a first side of the at least one subject and acquiring the light intensity values at the excitation and emission wavelengths includes acquiring the light intensity values at the excitation and emission wavelengths from the detector located on a second side of the at least one subject opposite the first side.

According to another aspect of the subject matter described herein, the detector comprises a camera.

According to another aspect of the subject matter described herein, controlling the light emanating from the light source to project the illumination pattern includes controlling a plurality of light emitting diodes (LEDs) arranged in a linear pattern to be simultaneously ON.

According to another aspect of the subject matter described herein, the LEDs are located in a transillumination module configured to hold the LEDs in proximity to the at least one subject.

According to another aspect of the subject matter described herein, controlling the light emanating from the light source to project the illumination pattern onto the at least one subject includes sequentially exciting successive rows and columns of the LEDs in an LED matrix.

According to another aspect of the subject matter described herein, controlling the light emanating from the light source to project the illumination pattern includes controlling a laser and one or more mirrors, or a galvanometer to generate at least two lines of laser light that are angularly offset from each other. In one example, the at least two lines may include two lines of laser light that are perpendicular to each other. In one example, rather than using a rotating polygonal mirror and two steering mirrors, a two-axis galvanometer may be used to scan one or more lines of laser light across a subject.

According to another aspect of the subject matter described herein, controlling the laser and the one or more mirrors to generate the at least two lines of laser light includes rotating a polygonal mirror to produce a line of laser light, reflecting the line of laser light onto the subject using a first steering mirror to produce the first scan line of laser light, reflecting the line of laser light onto the subject using a second steering mirror to produce the second scan line of laser light, and scanning the first and second scan lines of laser light across the subject by tilting the first and second steering mirrors.

According to another aspect of the subject matter described herein, controlling the light source to project the illumination pattern includes controlling a quasi-monochromatic light source to project the illumination pattern. The term “quasi-monochromatic light source” refers to a light source that is either filtered or otherwise designed to emit light within an absorption frequency (or wavelength) band of the fluorophore being illuminated within the subject.

According to another aspect of the subject matter described herein, a spatial illumination mask, which may be a virtual mask implemented by the light source or a physical mask located between the light source and the subject, may be used to limit illumination by the light source to a region occupied by the subject.

According to another aspect of the subject matter described herein, the at least one subject comprises at least one preclinical subject.

According to another aspect of the subject matter described herein, the at least one subject comprises a plurality of preclinical subjects simultaneously positioned on the imaging platform and acquiring the light intensity values at the emission wavelengths includes simultaneously acquiring the light intensity values for light emitted from the plurality of preclinical subjects.

According to another aspect of the subject matter described herein, generating the image includes generating a two-or three-dimensional image of the fluorescent sources within the at least one subject.

According to another aspect of the subject matter described herein, generating the image of the fluorescent sources includes constructing a weight matrix from the light intensity values at the excitation and emission wavelengths, inverting the weight matrix, and solving an equation for a concentration of the fluorescent sources within the at least one subject.

According to another aspect of the subject matter described herein, the method further includes acquiring at least two ultrasound images of the at least one subject simultaneously with the acquiring of the light intensity values at at least two emission wavelengths.

According to another aspect of the subject matter described herein, T generating the image of the fluorescent sources includes modeling excitation intensity at a point within the at least one subject resulting from the illumination pattern comprising at least one line using a Hankel function of the first kind, modeling emission intensity at a point on the detector as an integral over a volume occupied by the at least one subject of a product of the modeled excitation intensity, concentration of the fluorescence sources within the at least one subject, and Green's function at a fluorophore emission wavelength from a point within the at least one subject to the detector, and reconstructing normalized measurements of fluorescence intensity at a detector location given the acquired light intensity values and using the modeled emission and excitation intensities.

According to another aspect of the subject matter described herein, a system for fluorescence imaging tomography is provided. The system includes an imaging platform for holding at least one subject to be imaged. The system further includes a light source for projecting an illumination pattern comprising at least one line onto the at least one subject. The system further includes a detector for detecting light at excitation wavelengths produced by the light source and at emission wavelengths produced by fluorescent sources within the at least one subject. The system further includes an image acquisition controller for controlling light emanating from the light source to project the illumination pattern onto the at least one subject. The image acquisition controller may also control a spatial illumination mask computed from a photograph of the subject and configured to limit illumination by the light source to a region occupied by the subject. The system further includes an image reconstructor for generating an image of the fluorescent sources within the at least one subject based on the acquired light intensity values and outputting the image.

According to another aspect of the subject matter described herein, the image acquisition controller is configured to control the light source to project the illumination pattern onto the at least one subject for illuminating the at least one subject from a first side of the at least one subject and the detector is configured to acquire the light intensity values at the excitation and emission wavelengths at a second side of the at least one subject opposite the first side.

According to another aspect of the subject matter described herein, the light source comprises a plurality of LEDs arranged in a linear pattern, and the image acquisition controller is configured to control the LEDs in the linear pattern to be simultaneously ON.

According to another aspect of the subject matter described herein, the system further includes a transillumination module configured to hold the LEDs in proximity to the at least one subject.

According to another aspect of the subject matter described herein, the image acquisition controller is configured to control the light source to project the illumination pattern onto the at least one subject by sequentially exciting successive rows and columns of the LEDs in an LED matrix.

According to another aspect of the subject matter described herein, the system for fluorescence tomography includes one or more mirrors, the light source comprises a laser and the image acquisition controller is configured to control the laser to project laser light onto a first mirror of the plurality of mirrors, rotate the first mirror to produce a line of laser light, and reflect the line of laser light using first and second steering mirrors to produce first and second scan lines of laser light on the at least one subject and that are angularly offset from each other.

According to another aspect of the subject matter described herein, the image acquisition controller is configured to control tilting of the first and second steering mirrors to scan the first and second scan lines of laser light across the at least one subject.

According to another aspect of the subject matter described herein, the light source comprises a quasi-monochromatic light source for projecting the illumination pattern.

According to another aspect of the subject matter described herein, the imaging platform is configured to hold a plurality of preclinical subjects, and the image acquisition controller is configured to simultaneously acquire the light intensity values at the light emission wavelengths for light emitted from the plurality of preclinical subjects.

According to another aspect of the subject matter described herein, the image reconstructor is configured to generate a two-or three-dimensional image of the fluorescent sources within the at least one subject.

According to another aspect of the subject matter described herein, the image reconstructor is configured to generate the image of the fluorescent sources by constructing a weight matrix from the light intensity values at the excitation and emission wavelengths, inverting the weight matrix, and solving an equation for a concentration of the fluorescent sources within the at least one subject.

According to another aspect of the subject matter described herein, the system further includes an ultrasound transducer for acquiring at least two ultrasound images of the at least one subject simultaneously with the acquiring of the light intensity values at at least two emission wavelengths.

According to another aspect of the subject matter described herein, the system further includes at least one bandpass, or short-pass excitation filter for filtering light emanating from the light source.

According to another aspect of the subject matter described herein, the system further includes a spatial illumination mask for limiting light emitted by the light source to a region occupied by the at least one subject.

According to another aspect of the subject matter described herein, the system further includes at least one emission filter for filtering light emitted from the subject.

According to another aspect of the subject matter described herein, the light source includes a plurality of light emitting elements and the system includes an anti-crosstalk grid positioned on a light emitting side of the light emitting elements for reducing crosstalk between adjacent light emitting elements.

According to another aspect of the subject matter described herein, the system further includes a light pipe or focusing optics positioned on a light emitting side of the light source.

The subject matter described herein can be implemented in software in combination with hardware and/or firmware. For example, the subject matter described herein can be implemented in software executed by a processor. In one exemplary implementation, the subject matter described herein can be implemented using a non-transitory computer readable medium having stored thereon computer executable instructions that when executed by the processor of a computer control the computer to perform steps. Exemplary computer readable media suitable for implementing the subject matter described herein include non-transitory computer-readable media, such as disk memory devices, chip memory devices, programmable logic devices, and application specific integrated circuits. In addition, a computer readable medium that implements the subject matter described herein may be located on a single device or computing platform or may be distributed across multiple devices or computing platforms.

### BRIEF DESCRIPTION OF THE DRAWINGS

Exemplary implementations of the subject matter described herein will now be explained with reference to the accompanying drawings, of which:

FIG. 1 is a diagram illustrating exemplary components used for fluorescence imaging tomography;

FIG. 2A illustrates an example of scanning a light pattern comprising a line across a subject;

FIG. 2B is a perspective view of a galvanometer including two mirrors usable to scan a line of laser light across a subject;

FIGS. 2C-2E illustrate an example of a rotating polygonal mirror and two steering mirrors. The rotating polygonal mirror generates a line across each steering mirror. One steering mirror tilts to move a first scan line in the X-direction, and the other steering mirror tilts to move a second scan line in the Y-direction at the specimen plane;

FIG. 3 illustrates an example of a light source comprising an LED array that can be used to generate lines of light in rows and columns and project the lines of light onto the subject;

FIG. 4 includes diagrams illustrating results of simulation of excitation of a single line of light sources illuminating a diffuse slab;

FIG. 5 is a block diagram illustrating an exemplary system for fluorescence imaging tomography;

FIG. 6 is a flow chart illustrating an example of an image acquisition process that may be used to capture excitation and emission images of a subject having one or fluorescence sources within the subject;

FIG. 7 is a flow chart illustrating an exemplary image reconstruction process that may be used to reconstruct an image of fluorophore concentration within a subject;

FIG. 8 is a schematic diagram illustrating an exemplary transillumination module suitable for use as the light source in the system for fluorescence imaging tomography illustrated in FIG. 5;

FIG. 9 is a perspective view of anti-crosstalk vanes that may be included in an optical elements and anti-crosstalk layer of the transillumination module illustrated in FIG. 8 to reduce crosstalk between adjacent LEDs;

FIG. 10 is a top view of a grid of the anti-crosstalk vanes illustrated in FIG. 9;

FIG. 11 is a perspective view of a light pipe that may be included in each of the anti-crosstalk vanes of FIG. 9;

FIGS. 12A-12C are perspective views illustrating examples of optical elements that may be included in optical elements and anti-crosstalk layer of the transillumination module of FIG. 8;

FIG. 13 is a schematic diagram of a cartesian motion stage suitable for use to move the light source and/or the imaging platform in the system for fluorescence imaging tomography illustrated in FIG. 5;

FIG. 14 is a schematic diagram of a multi-subject imaging platform suitable for use as the imaging platform in the system for fluorescence imaging tomography illustrated in FIG. 5;

FIG. 15 is a schematic diagram illustrating an array of transillumination modules suitable for use with the multi-subject platform illustrated in FIG. 14;

FIG. 16 is a flow chart illustrating exemplary overall steps for a method for fluorescence imaging tomography;

FIG. 17 is an example of 2D reconstructed image slices generated using the reconstruction method described herein for a pair of adjacent, simulated fluorophores within a simulated subject

FIGS. 18A-18C illustrate another example of an anti-crosstalk grid that may be used in an anti-crosstalk and optical elements layer of the transillumination module of FIG. 8;

FIGS. 19A-19C illustrate an experimental setup for using linear illumination patterns to illuminate fluorophores within a subject;

FIGS. 20A-20C respectively illustrate normalized data, excitation data, and emission data from scanning lines of light created by an LED array across a tissue mimicking phantom;

FIGS. 21A and 21B illustrate a schematic of the LED matrix and a phantom-mimicking slab for the experimental results illustrated in FIGS. 22A-22D; and

FIGS. 22A-22D illustrate renderings of a fluorophore located in the phantom-mimicking slab.

### DETAILED DESCRIPTION

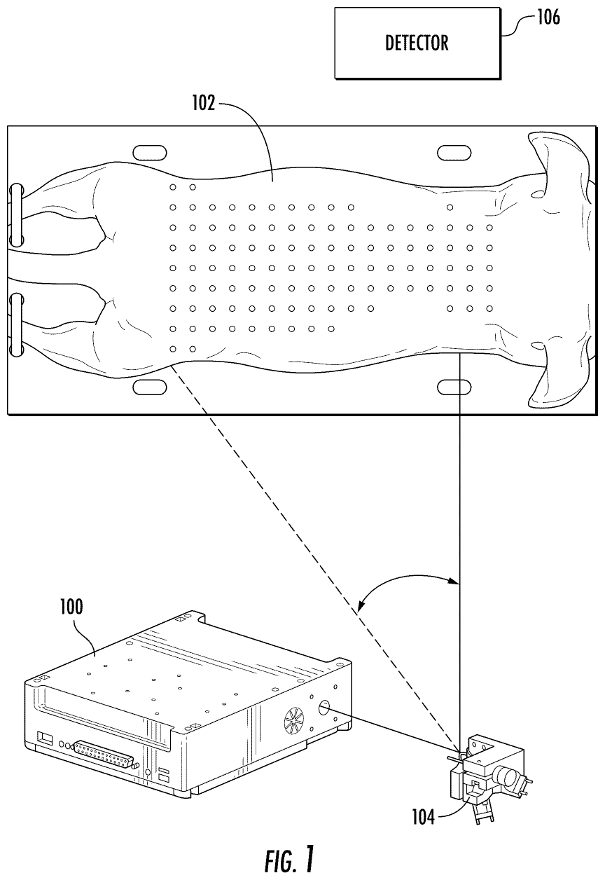

The subject matter described herein improves conventional fluorescence tomography by scanning a linear illumination pattern across a subject or projecting the linear illumination pattern onto the subject at different locations and reconstructing a fluorescence image resulting from the linear excitation. FIG. 1 is a diagram illustrating exemplary components used for fluorescence imaging tomography. Referring to FIG. 1, light from a laser light source 100 is scanned across the underside of a subject 102, which in the illustrated example is a mouse, by a computer controlled galvanometer 104. A detector 106 located on the side of the subject opposite the light source detects light emitted by fluorophores in the subject. An image reconstructor (not shown in FIG. 1) generates an image showing the 3D distribution of fluorophores in the subject.

In the example illustrated in FIG. 1, the illumination pattern is a plurality of discrete points, i.e., the laser is off between successive scanning locations. Scanning a subject with a laser to produce a pattern of discrete points is time consuming, as is the corresponding image reconstruction to produce an image of the fluorophores within the subject.

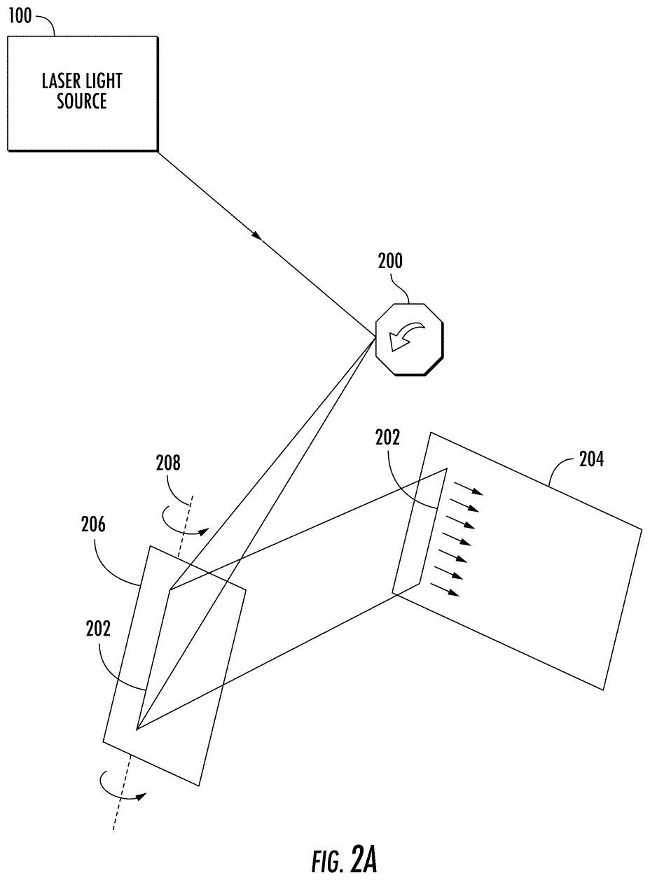

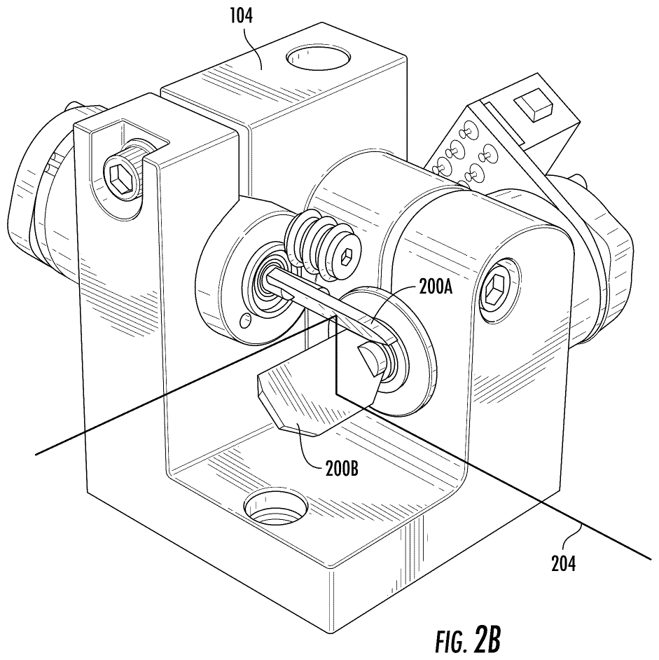

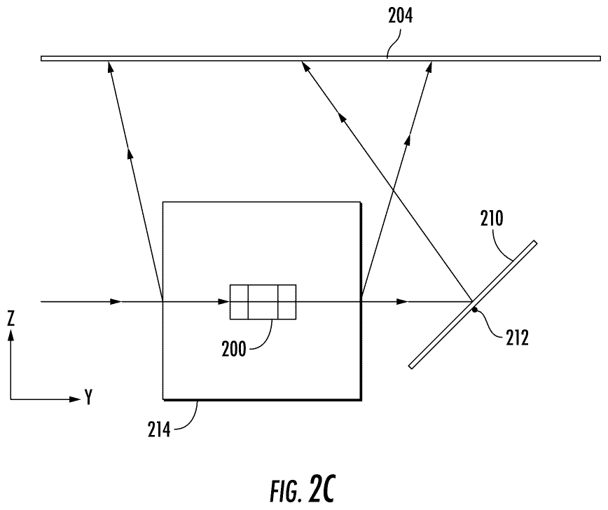

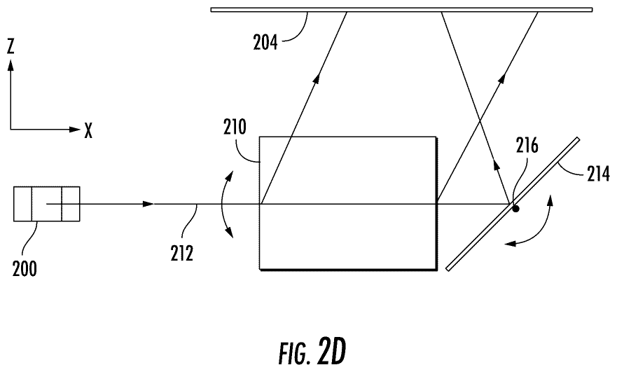

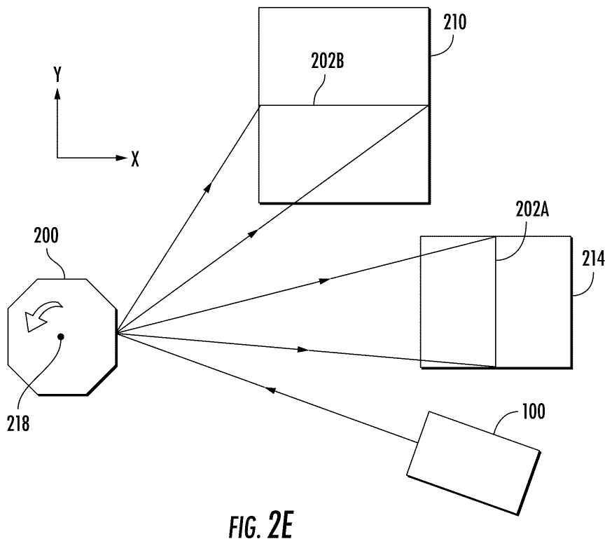

To avoid these difficulties, in one example, the subject matter described herein includes scanning a light pattern across the subject where the light pattern comprises a line. FIG. 2A illustrates an example of scanning a light pattern comprising a line across a subject. Referring to FIG. 2A, light from laser light source 100 is projected onto a rotating polygonal mirror 200 to produce a pattern comprising a line 202, which is scanned across a specimen stage 204 by a steering mirror 206, which tilts about an axis 208. In the illustrated example, line 202 is scanned across specimen stage 204 by tilting steering mirror 206 that projects line 202 onto specimen stage 204 while laser light source 100 and mirror 200 remain stationary (except for the rotation of mirror 200 to produce line 202). In an alternate example, laser light source 100 and rotating mirror 200 and/or galvanometer 104 are located below subject 102, which may lie on a transparent imaging platform. Laser light source 100, galvanometer 104, and/or mirror 200 may be controlled programmatically to project a sequence of lines onto the subject. Laser light source 100 can emit a multiplicity of excitation wavelengths with variable power and laser exposure times. The lines can be drawn multiple times to increase the total energy deposited on the subject. Detector 106 may be positioned above subject 102 such that at least a portion of the surface of the subject 102 is within the camera field of view. A band-pass, short pass, or long pass emission filter is placed between the imaging sensor and the subject. The emission filter only allows the targeted emission wavelength of the fluorescent probe.

FIG. 2B is a perspective view of a galvanometer including two mirrors useable to scan a line of laser light across a subject. In FIG. 2B, galvanometer 104 includes two mirrors 200A and 200B used to scan line 204 of laser light across the subject.

In one example, two camera exposures are required: one with an excitation band-pass filter that only allows the excitation (fluorophore absorption) wavelength to be recorded and one with an emission band-pass filter that only allows the emission (fluorophore emission) wavelength to be recorded. During scanning, a single vertical (constant X) or horizontal (constant Y) line is scanned by the laser and galvanometer while the camera shutter is open. In this example, the image(s) of the single line are acquired and saved for processing. Subsequent line positions are acquired by the laser/galvo/camera system and stored. The laser system is calibrated such that the position of the laser line on the subject is known. Projected laser lines on the subject are acquired with each laser line separated by a specified pitch (separation) such that a region of interest is spanned by the totality of laser lines. A full set of lines are scanned in the X-Y plane, where the full scan includes rows and columns of light that are perpendicular to each other. The set of laser lines can be scanned at different pitches to increase the reconstruction resolution dynamically. In this example, lines may be separated by N*P, where N is the octave of the scan and P is the minimum pitch required. The line scans proceed in both directions (X,Y) of the X-Y plane over the full field of view of the specimen. At each octave N={M, M/2, M/4, . . . , 1} the field of view can be reduced by a factor of 2 to isolate a region of interest with higher resolution.

In another example, multiple laser lines are projected and exposed in the same image. The laser lines are parallel to each other and spaced far enough apart so that the diffuse transmission of light at one line is less than 1/κ_{fl}, where κ_{fl} is the diffusion length defined in Eq. 3 The distance between laser lines at the surface is the pitch. The distance between laser lines is at least 10 times the mean-free-path, or scattering length, of the medium. Fewer camera exposures are required than single line embodiments. One set of parallel lines are projected and exposed, then a perpendicular set of lines are projected and exposed.

In one example, a set of equally-spaced, parallel, projected laser lines along the X-direction can be displaced perpendicular to the line direction (along the Y-direction) by an amount Q<P, where Q is the displacement and P is the spacing between the lines. Camera exposures are acquired for each position Q. Corresponding displacements (along X) are recorded for lines projected along the Y-direction.

FIGS. 2C-2E illustrate an example of a rotating polygonal mirror and two steering mirrors. The rotating polygonal mirror generates a line across each steering mirror. One steering mirror tilts to move the line in the X-direction, and the other steering mirror tilts to move the line in the Y-direction at the specimen plane. FIG. 2C shows the mirrors and the specimen stage from the Y-Z plane, where y is one direction across the specimen stage and z is a direction into the specimen stage. In FIG. 2C, rotating polygonal mirror 200 rotates to produce a line from a laser light source (not shown in FIG. 2C) onto a Y-direction steering mirror 210. Y-direction steering mirror 210 tilts about an axis 212 that extends in the X-direction to scan a line that extends in the X-direction across specimen stage 204 in the Y-direction. An X-direction steering mirror 214 tilts about an axis that extends in the Y-direction to scan a line that extends in the Y-direction across specimen stage 204 in the X-direction.

FIG. 2D shows the mirrors and the specimen stage from the X-Z plane, where the X-direction is a direction orthogonal to the Y-direction in the plane of the specimen stage. In FIG. 2D, axis of rotation 216 of X-direction steering mirror 214 is illustrated.

FIG. 2E illustrates the polygonal mirror and the steering mirrors from the X-Y plane. The X-Y plane is the plane of the specimen stage, which is not shown in FIG. 2E. As shown in FIG. 2E, polygonal mirror 200 tilts about an axis 218 to produce scan line 202A that extends in the Y-direction and that is scanned in the X-direction across the specimen stage by X-direction steering mirror 214. Simultaneously with the scanning of scan line 202A across the specimen stage, polygonal mirror 200 produces scan line 202B that extends in the X-direction and that is scanned in the Y-direction across the scanning stage by Y-direction scanning mirror 210. Thus, as illustrated in FIGS. 2C-2E, light from a single light source can be simultaneously scanned in orthogonal directions across the specimen stage.

In the example illustrated in FIGS. 2A-2E, laser light source 100 and rotating polygonal mirror 200 are used to generate a projected laser line. In an alternate example, a laser light source and an optical element can be used to generate a projected laser line. In yet another example, a laser light source and cylindrical lens can be used to generate a projected laser line. In yet another example, a laser light source and a lenticular array can be used to generate a projected laser line.

In an alternate example, rather than using a laser light source to create the line of light that is scanned across the subject, a light emitting diode (LED) array may be used to create lines of light that are projected onto the subject at different locations. FIG. 3 illustrates an example of a light source comprising an LED array that can be used to generate lines of light in rows and columns and project the lines of light onto the subject. Referring to FIG. 3, light source 100 comprises an LED array comprising a plurality of individually addressable LEDs. Rather than activating the LEDs one at a time to illuminate the subject with individual points of light, the subject matter described herein may include generating lines of light by activating a plurality of the LEDs in a column or row of LEDs to be simultaneously on. For example, an image acquisition controller may control a line of LEDs arranged in a column, such as column 300, to be simultaneously on. Similarly, the image acquisition controller may control LEDs in a row, such as row 302, to be simultaneously on. In one example, the image acquisition controller may sequentially activate columns and rows of LEDs to project lines of light onto the subject at different row and column locations. In an excitation run used to quantify the excitation light present in the subject, successive rows and columns may be sequentially activated with an excitation filter in front of the detector. In an emission run used to quantify light emitted by fluorophores within the subject, successive rows and the columns may be sequentially activated with an emission filter positioned in front of the detector.

In one example, light source 100 utilizes at least one array of LEDs operating at one or more emission wavelengths. The emission wavelength of the LEDs may be selected to match a peak in fluorophore absorption spectra of the fluorophore being imaged within the subject. A narrow band-pass filter may be employed to cover the LED array. The band-pass or short-pass filter is selected to match the peak emission wavelength of the LED, the peak absorption band of a target fluorophore, or to minimize bleed-through at the target fluorophore emission band.

In one example, a transillumination module (see FIG. 8) is constructed. The transillumination module contains one or more layers consisting of:
One or more LED arrays
Zero or more optical elements
Zero or more opaque or reflective vanes or cut-outs situated between pairs of LED emitters
Zero or more band-pass or short-pass filters
A transparent or translucent waterproof coating

In one example, the transillumination module consists of an LED array and transparent or translucent waterproof coating. The transillumination module may be immersed in non-conducting oil. One or more thin optical elements may be situated between one or more LEDs in the array and the subject. The optical element may be one or more of the following:
stacked ball lenses
Fresnel lenses
lenticular strips
cylindrical lenses
light pipes

One or more transillumination modules may be mounted to a linear or X-Y positioner stage that is driven by one or more stepper motors. The transillumination module(s) may be in direct contact with the specimen. One or more LEDs of the transillumination module may be controlled by pulse-width-modulation. One or more LEDs of the transillumination module may be independently addressable. The LED array may be connected to a microcontroller board.

In one example, one or more equally spaced rows or columns of illuminated LEDs constitute a line. More precisely, a line is composed of one or more colinear illuminated LEDs. The lines are projected onto the subject either by direct contact (no intervening optical element), one or more optical elements between the subject and the LEDs, or a combination of optical elements and a band-pass filter between the subject and the LEDs.

In one example, the rows/columns of LEDs are illuminated in equally spaced lines—forming a comb pattern—during a camera exposure. In subsequent exposures, the pitch and extent of the comb pattern can be altered to modify the resolution of the reconstructed image or the illuminated region of interest. In one example, the transillumination module can be moved with sufficient precision to increase reconstructed image resolution.

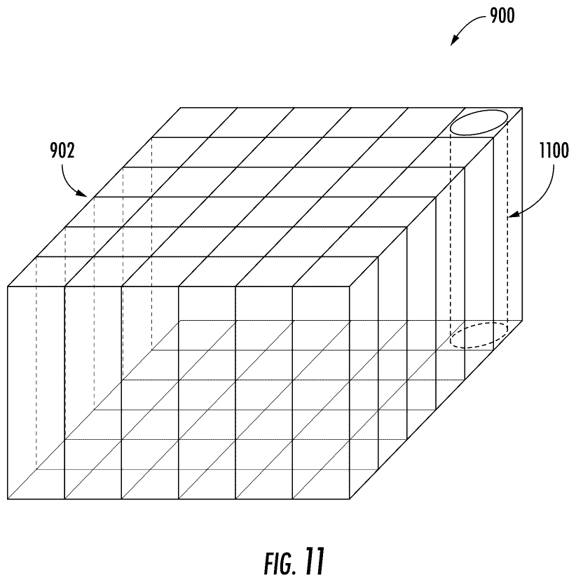

In one example, a multiplicity of transillumination modules (see FIG. 15) can be mounted to a translation stage (see FIG. 13). Each transillumination module may be composed of a matched set of LEDs and band-pass filter. The LED/band-pass filter combination is selected to match an optimal excitation wavelength. In one example, the transillumination module can consist of an alternating set of monochromatic LEDs arranged periodically. For example, an array row or column can be organized λ₀, λ₁, λ₂, λ₃, λ₄, λ₀, λ₁, λ₂, λ₃, λ₄, λ₀, λ₁λ₂, . . . . In one example, each LED may be independently addressable to emit light at two or more wavelengths.

In one example, each LED element is coupled to a small band pass filter tuned to the LED emission wavelength. A grid of opaque or reflective vanes, cut-outs, or tubes may separate each LED to prevent cross-talk (illumination of a particular point by two or more LED emitters) at the surface of the subject or specimen.

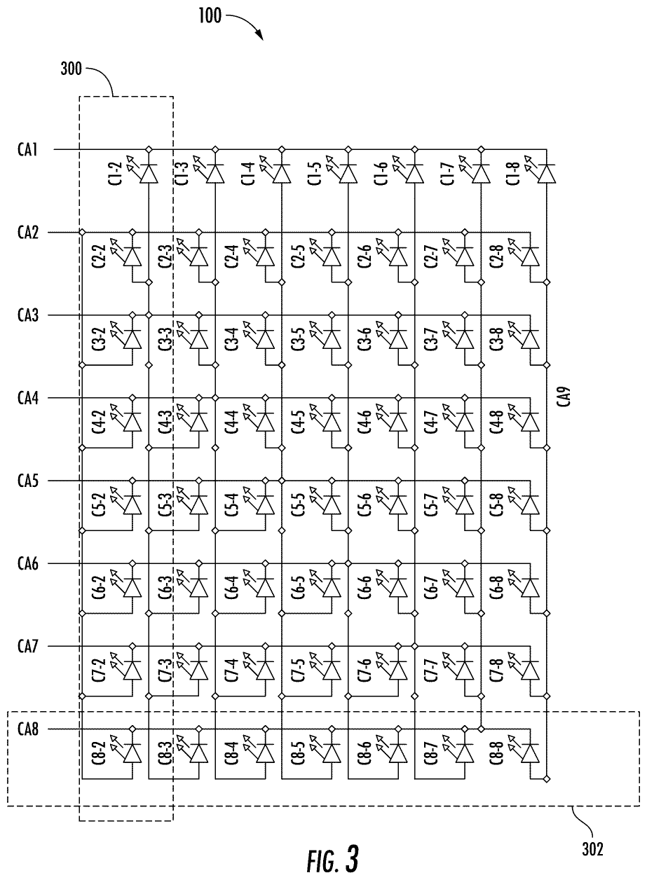

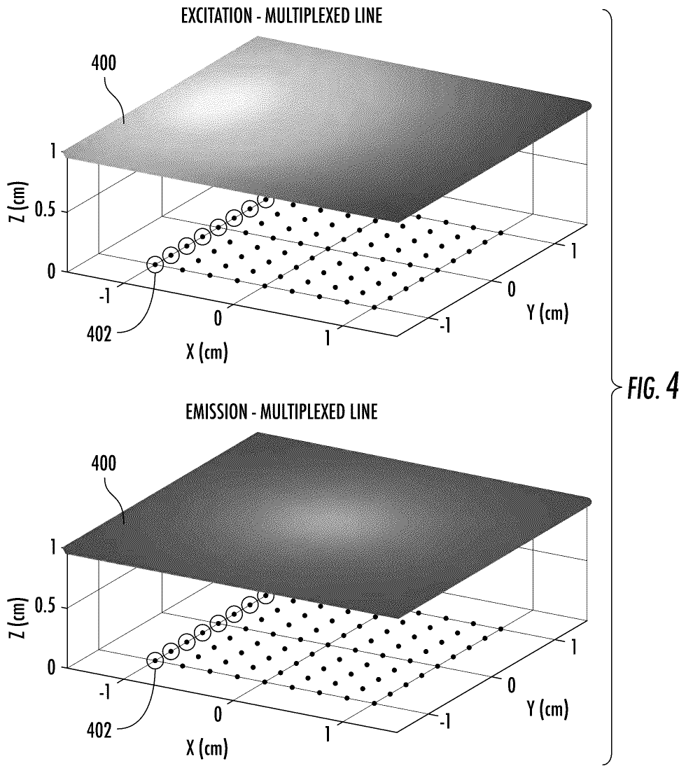

FIG. 4 includes diagrams illustrating results of simulation of excitation of a single line of light sources illuminating a diffusely scattering slab. In FIG. 4, the top diagram illustrates results of a simulation of the excitation of a line of LEDs and the resulting excitation pattern in the camera image plane, and the bottom diagram illustrates results of a simulation of an emission pattern in the camera image plane from a fluorophore located in the center of the diffusely scattering slab. In FIG. 4, rectangles represent the camera image plane 400, points 402 in the lower part of each image located at z=0 represent LEDs. The diffuse slab is represented by the area between the LEDs (points 402) and the camera imaging plane 400. Excitation is imaged at the top surface of the slab. The emission image is filtered at the peak emission wavelength band of a fluorophore. In subsequent acquisitions, the line pattern is shifted by one unit along X-direction until all of the lines in the Y-direction are acquired. Corresponding sets of images are acquired with the line patterns of LEDs activated along the X-direction.

One benefit of acquiring fluorescence images of lines of light scanned or successively projected at different locations across a subject is an improvement in image reconstruction. The current point-based image reconstruction will first be described, followed by a description of reconstruction of images from line sources.

Due to the fact that each individual source has a limited coverage inside a subject, such as a mouse, the idea is to illuminate several areas of the mouse simultaneously, reducing the experimental time while retaining the same quality of the reconstruction. One possible outcome is that the reconstruction data improves due to an increase in the signal to noise ratio.

### 1. Introduction: Current Reconstruction Method

The current way of reconstructing fluorescence imaging tomography data is the following: we have a set of Ns sources, and we measure the intensity at the surface of the mouse at Nd detectors. Assuming that the mouse is on average an optically homogeneous medium, we can predict the fluorescence intensity at a particular detector due to a particular source as:

$${U}^{e m} ( {r}_{s} , {r}_{d} ) = {σ}_{a} Φ ( {λ}_{e m} ) {\int }_{V} {U}^{e x c} ( {r}_{s} , r ) C ( r ) {G}^{e m} ( r , {r}_{d} ) {d}^{3} r , \qquad ( 1 )$$

where σ_{α}is the absorption cross-section at the excitation wavelength for the fluorophore, Φ(λₑₘ) is the fluorophore's quantum yield at the measured emission wavelength, U^{exc}(rₛ, r) is the excitation intensity at point r inside volume V, C(r) is the fluorophore concentration at position r, and G^{em}(r, r_{d}) is the Green function at the emission wavelength from point r inside the volume to the detector:

$${G}^{e m} ( r , {r}_{d} ) = \frac{exp ( i {κ}_{f l} \vert r - {r}_{d} \vert )}{4 π D \vert r - {r}_{d} \vert} , \qquad ( 2 )$$

wherein κ_{fl} is the wavenumber at the emission wavelength:

$${κ}_{f l} = \sqrt{- {μ}_{a} ( {λ}_{f l} ) / D} , \qquad ( 3 )$$

being related by its inverse the diffusion length, i.e., the distance light has to travel to decay by 1/e, LD =\sqrt{D/μ_{α}}. Eq. (1) is typically represented with the concentration including a calibration factor for each fluorophore as:

$${U}^{e m} ( {r}_{s} , {r}_{d} ) = {\int }_{V} {U}^{e x c} ( {r}_{s} , r ) {C}_{ϕ} ( r ) {G}^{e m} ( r , {r}_{d} ) {d}^{3} r , \qquad ( 4 )$$

where the concentration is now expressed as C_{ϕ}(r) as a reminder that each fluorophore needs to be calibrated to account for the difference in quantum yield and absorption cross-section. Considering that the excitation intensity may be described for a homogeneous medium as:

$${U}^{e x c} ( {r}_{s} , r ) = {S}_{0} {G}^{e x c} ( {r}_{s} , r ) = {S}_{0} \frac{exp ( i {κ}_{e x c} \vert {r}_{s} - r \vert )}{4 π D \vert {r}_{s} - r \vert} , \qquad ( 5 )$$

with κ_{exc}=−μ_{α}(λ_{exc}) /D, and Sₒ being the source power per unit volume, Eq. (4) may be written as:

$${U}^{e m} ( {r}_{s} , {r}_{d} ) = {S}_{0} {\int }_{V} {G}^{e x c} ( {r}_{s} , r ) {C}_{ϕ} ( r ) {G}^{e m} ( r , {r}_{d} ) {d}^{3} r . \qquad ( 6 )$$

To make the reconstruction more robust and remove the source component, what is done is to normalize the data using the excitation measurement:

$${U}^{n o r m} ( {r}_{s} , {r}_{d} ) = \frac{{U}^{e m} ( {r}_{s} , {r}_{d} )}{{U}^{e x c} ( {r}_{s} , {r}_{d} )} = {\int }_{V} \frac{{G}^{e x c} ( {r}_{s} , r ) {G}^{e m} ( r , {r}_{d} )}{{G}^{e x c} ( {r}_{s} , {r}_{d} )} {C}_{ϕ} ( r ) {d}^{3} r . \qquad ( 7 )$$

Discretizing the volume as M voxels in Eq. (7), we may write the normalized measurements at a source i and a detector j as:

$${U}_{i , j}^{n o r m} = {\sum }_{m = 1}^{M} \frac{{G}^{e x c} ( {r}_{i} , {r}_{m} ) {G}^{e m} ( {r}_{m} , {r}_{j} )}{{G}^{e x c} ( {r}_{i} , {r}_{j} )} {C}_{ϕ} ( r ) Δ V . \qquad ( 8 )$$

We can write this in matrix form for detector j as:

$${[ {𝕌}_{j}^{{N}_{s}} ]}_{{N}_{s} \times 1} = {[ \begin{matrix}{U}_{1 , j}^{norm} \\ ⋮ \\ {U}_{{N}_{s , j}}^{norm}\end{matrix} ]}_{{N}_{s} \times 1} = {{[ \begin{matrix}{W}_{1}^{1 , j} & … & {W}_{M}^{1 , j} \\ ⋮ & ⋱ & ⋮ \\ {W}_{1}^{{N}_{s} , j} & … & {W}_{M}^{{N}_{s} , j}\end{matrix} ]}_{{N}_{s} \times M} [ \begin{matrix}{C}_{1} \\ ⋮ \\ {C}_{M}\end{matrix} ]}_{M \times 1} . \qquad ( 9 )$$

By having several detector measurements (for example, pixels in an image), we can stack the matrices in Eq. (9) and improve the quality of the reconstruction:

$${[ \begin{matrix}{𝕌}_{1}^{{N}_{s}} \\ ⋮ \\ ⋮ \\ {𝕌}_{{N}_{d}}^{{N}_{s}}\end{matrix} ]}_{( {N}_{s} \times {N}_{d} ) \times 1} = {[ \begin{matrix}{U}_{1 , 1}^{norm} \\ ⋮ \\ {U}_{{N}_{s} , 1}^{norm} \\ ⋮ \\ ⋮ \\ {U}_{1 , {N}_{d}}^{norm} \\ ⋮ \\ {U}_{{N}_{s} , {N}_{d}}^{norm}\end{matrix} ]}_{( {N}_{s} \times {N}_{d} ) \times 1} = {{[ \begin{matrix}{W}_{1}^{1 , 1} & … & {W}_{M}^{1 , 1} \\ ⋮ & ⋱ & ⋮ \\ {W}_{1}^{{N}_{s} , 1} & … & {W}_{M}^{{N}_{s} , 1} \\ & ⋮ & \\ & ⋮ & \\ {W}_{1}^{1 , {N}_{d}} & … & {W}_{M}^{1 , {N}_{d}} \\ ⋮ & ⋱ & ⋮ \\ {W}_{1}^{{N}_{s} , {N}_{d}} & … & {W}_{M}^{{N}_{s} , {N}_{d}}\end{matrix} ]}_{( {N}_{s} \times {N}_{d} ) \times M} [ \begin{matrix}{C}_{1} \\ ⋮ \\ {C}_{M}\end{matrix} ]}_{M \times 1} .$$

In this equation, [symbol] _{(N}_{ₛ}×N_{d})×M is usually termed the weight matrix for a set of Nₛ×N_{d} measurements and M voxels to be imaged:

$${[ 𝕌 ]}_{( {N}_{s} \times {N}_{d} ) \times 1} = {{[ 𝕎 ]}_{( {N}_{s} \times {N}_{d} ) \times M} [ ℂ ]}_{M \times 1} .$$

The larger the number of independent measurements with high SNR, the better the reconstruction. The values of C₁. . . C_{M} may be obtained by inverting the above matrix by using, for example, the Algebraic Reconstruction Technique (ART):

$${[ ℂ ]}_{M \times 1} = {{\{ {[ 𝕎 ]}_{( {N}_{s} \times {N}_{d} ) \times M} \}}^{- 1} [ 𝕌 ]}_{( {N}_{s} \times {N}_{d} ) \times 1} . \qquad ( 9.1 )$$

### 2. Multiplexing by Selecting Several Sources Simultaneously

There are several ways to introduce multiplexing in fluorescence imaging tomography. The idea is to select which sources will be included, the resulting measurement a sum of these. For example, for a collection of 6 sources [symbol] _{N}_{ₛ}×1 we may want to turn on only two:

$${𝕊}_{{N}_{s} \times 1} = [ \begin{matrix}1 \\ 0 \\ 0 \\ 1 \\ 0 \\ 0\end{matrix} ] ,$$

this would represent that source positions 1 and 4 are turned on simultaneously. The resulting measurement would thus be for a single detector position:

$${m}_{j} = {{[ {U}_{1 , 1}^{n o r m} … {U}_{{N}_{s} , 1}^{n o r m} ]}_{1 \times {N}_{s}} [ 𝕤 ]}_{{N}_{s} \times 1} = {\sum }_{i}^{{N}_{s}} {S}_{i} \cdot {U}_{i , j}^{n o r m} = {( {{[ 𝕤 ]}_{1 \times {N}_{s}} [ \begin{matrix}{W}_{1}^{1 , j} & … & {W}_{M}^{1 , j} \\ ⋮ & ⋱ & ⋮ \\ {W}_{1}^{{N}_{s} , j} & … & {W}_{M}^{{N}_{s} , j}\end{matrix} ]}_{{N}_{s} \times M} ) [ \begin{matrix}{C}_{1} \\ ⋮ \\ {C}_{M}\end{matrix} ]}_{M \times 1} .$$

For the total number of detectors (or, for example, pixels in an image), a single source pattern would yield the result:

$${[ 𝕄 ]}_{{N}_{d} \times 1} \times = {{[ \begin{matrix}{U}_{1 , 1}^{norm} & … & {U}_{{N}_{s} , 1}^{norm} \\ ⋮ & ⋱ & ⋮ \\ {U}_{1 , {N}_{d}}^{norm} & … & {U}_{{N}_{s} , {N}_{d}}^{norm}\end{matrix} ]}_{{N}_{d} , {N}_{s}} [ 𝕤 ]}_{{N}_{s} \times 1} = {[ {\sum }_{i}^{{N}_{s}} {S}_{i} \cdot {U}_{i , 1}^{n o r m} … {\sum }_{i}^{{N}_{s}} {S}_{i} \cdot {U}_{i , {N}_{d}}^{n o r m} ]}_{{N}_{d} \times 1} = {{[ {{[ 𝕤 ]}_{1 \times {N}_{s}} [ \begin{matrix}{W}_{1}^{1 , 1} & … & {W}_{M}^{1 , 1} \\ ⋮ & ⋱ & ⋮ \\ {W}_{1}^{{N}_{s} , 1} & … & {W}_{M}^{{N}_{s} , 1}\end{matrix} ]}_{{N}_{s} \times M} {… [ 𝕤 ]}_{1 \times {N}_{s}} {[ \begin{matrix}{W}_{1}^{1 , {N}_{d}} & … & {W}_{M}^{1 , {N}_{d}} \\ ⋮ & ⋱ & ⋮ \\ {W}_{1}^{{N}_{s} , {N}_{d}} & … & {W}_{M}^{{N}_{s} , {N}_{d}}\end{matrix} ]}_{{N}_{s} \times M} ]}_{{N}_{d} \times M} [ \begin{matrix}{C}_{1} \\ ⋮ \\ {C}_{M}\end{matrix} ]}_{M \times 1} .$$

Building a set of κ source patterns [ [symbol] ]_{1×N}_{ₛ} we would end up with κ multiplexed measurements.

### 2.1 Line Source Implementation

As a particular example of the multiplexing approach mentioned in this section, we may use a line as an illumination pattern, instead of the point used traditionally. The expression of the excitation based on a line would be, assuming the line extends on the y-axis:

$${U}_{l i n e}^{e x c} ( {x}_{s} , {z}_{s} ; r ) = \frac{{S}_{0}}{4 π D} {\int }_{- ∞}^{+ ∞} \frac{exp ( i {κ}_{e x c} \sqrt{{( {x}_{s} - x )}^{2} + {( {y}_{s} - y )}^{2} + {( {z}_{s} - z )}^{2}} )}{\sqrt{{( {x}_{s} - x )}^{2} + {( {y}_{s} - y )}^{2} + {( {z}_{s} - z )}^{2}}} d {y}_{s} ,$$

Which since it is a 2D source may be expressed in terms of the Hankel function of the first kind,

$${H}_{0}^{( 1 )}$$

as:

$${U}_{l i n e}^{e x c} ( {x}_{s} , {z}_{s} ; r ) = \frac{{S}_{0}}{4 D} i {H}_{0}^{( 1 )} ( {κ}_{e x c} \sqrt{{( {x}_{s} - x )}^{2} + {( {z}_{s} - z )}^{2}} ) , \qquad ( 10 )$$

and the corresponding emission would be given by the equivalent of Eq. (4):

$${U}_{l i n e}^{e m} ( {x}_{s} , {z}_{s} ; {r}_{d} ) = {\int }_{V} {U}_{l i n e}^{e x c} ( {x}_{s} , {z}_{s} ; r ) {C}_{ϕ} ( r ) {G}^{e m} ( r , {r}_{d} ) {d}^{3} r . \qquad ( 11 )$$

Note that in this equation, the Green's function from the voxel to the detector is the regular 3D Green's function.

Following the above, we may construct the normalized measurements for a line source as:

$${U}_{i , j}^{n o r m} = {\sum }_{m = 1}^{M} \frac{i {H}_{0}^{( 1 )} ( \sqrt{{{κ}_{e x c} ( {x}_{i} - {x}_{m} )}^{2} + {( {z}_{i} - {z}_{m} )}^{2}} ) {G}^{e m} ( {r}_{m} , {r}_{j} )}{i {H}_{0}^{( 1 )} ( {κ}_{e x c} \sqrt{{( {x}_{i} - {x}_{j} )}^{2} + {( {z}_{i} - {z}_{j} )}^{2}} )} {C}_{ϕ} ( r ) Δ V . \qquad ( 12 )$$

Note

$$i {H}_{0}^{( 1 )}$$

always yields a positive and real number when dealing with pure imaginary values for κ_{exc} as in our case. We may now construct the matrix of measurements as in Eq. (9).

### 2.2 Discrete Line Source Implementation

In the case where instead of a line source (such as that given by a laser impinging on a cylindrical lens, for example), we have a line of discrete sources, we could implement the same approach as shown in 2.1, by converting the integral over the span of the line source to a discrete sum of Np sources separated a distance of Δyₚ between them.

$${U}_{l i n e}^{e x c} ( {x}_{s} , {z}_{s} ; r ) = \frac{{S}_{0}}{4 π D} {\sum }_{p = 1}^{{N}_{p}} \frac{exp ( i {κ}_{e x c} \sqrt{{( {x}_{s} - x )}^{2} + {( {y}_{p} - y )}^{2} + {( {z}_{s} - z )}^{2}} )}{\sqrt{{( {x}_{s} - x )}^{2} + {( {y}_{p} - y )}^{2} + {( {z}_{s} - z )}^{2}}} Δ {y}_{p} . \qquad ( 13 )$$

With the above we may now construct the normalized measurements and the weight matrix as in Eq. (9).

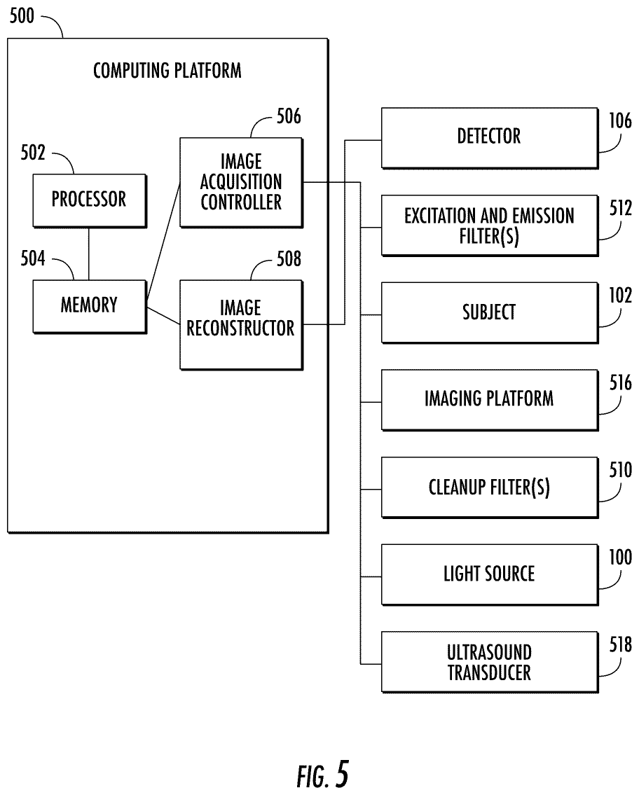

The following sections describe examples of image acquisition and reconstruction processes. The processes may be implemented using the system for fluorescence imaging tomography illustrated in FIG. 5. Referring to FIG. 5, a system for fluorescence imaging tomography includes a computing platform 500 including at least one processor 502 and memory 504. The system further includes an image acquisition controller 506 that controls acquisition of an image of fluorophore concentration in subject 102 and an image reconstructor 508 that reconstructs an image of the fluorophore concentration within subject 102. Image acquisition controller 506 and image reconstructor 508 may be implemented using computer executable instruction stored in memory 504 and executed by processor 502.

The system further includes light source 100 that creates a line of light, which is scanned across subject 102 to excite fluorophores in subject 102 and cause the fluorophores to emit light. As indicated above, in one example, light source 100 may be a laser light source. In another example, light source 100 may be an array of LEDs. In yet another example, light source 100 may be a broadband light source, such as a tungsten fiber optic light source that generates noncoherent light. One or more cleanup filters 510 may filter the light from light source 100 to generate light of a desired wavelength to excite the fluorophores within subject 102. For example, if the fluorophore being used is an IVISense 680 fluorescent cell labeling dye available from Revvity, Inc., cleanup filters 510 and light source 100 may be configured to generate light in a wavelength centered at 640 nanometers, causing the fluorophores to emit light at a peak wavelength of 700 nanometers. If the fluorophore being used is an IVISense 750 fluorescent cell labeling dye, light source 100 and cleanup filters 510 may generate light with a wavelength centered at 740 nanometers, causing the fluorophore to emit light centered at 780 or 800 nanometers.

Excitation and emission filters 512 may be positioned in front of detector 106 to filter excitation and emission light so that detector 106 receives light at the desired wavelengths. For example, during an excitation image capture where the purpose of the capture is to quantify the excitation light distribution in subject 102 for image reconstruction purposes, excitation and emission filters 512 may be configured to allow the excitation light wavelengths to pass to detector 106 and filter out other wavelengths. During an emission image capture, excitation and emission filters 512 may be configured to allow light to pass in the wavelength range expected from the fluorophores being used and to filter out other wavelengths.

The system illustrated in FIG. 5 may also include a spatial illumination mask created from an image of the subject and designed to prevent light from bypassing the subject from reaching and possibly damaging the detector. In one example, the spatial illumination mask may be implemented by light source 100. For example, if light source 100 is an array of LEDs or optical fibers connected to a laser, the spatial illumination mask may be implemented virtually by only activating the LEDs or only exciting the optical fibers that are within the region occupied by the subject. Pixels or optical fibers that are outside of the region occupied by the subject would be turned off or deactivated. In another example, the spatial illumination mask may be implemented using a material designed to block light that is outside of the region occupied by the subject. For example, the spatial illumination mask may be implemented using a microelectromechanical system (MEMs) array, a liquid crystal display (LCD), or other device designed to block light outside of the region occupied by the subject.

Detector 106 may be any suitable detector for detecting light at the excitation and emission wavelengths. In one example, detector 106 comprises a camera. In another example, detector 106 may be a photodiode or phototransistor array configured to detect light at the excitation and emission wavelengths.

An imaging platform 516 includes a substrate on which one or more subjects being imaged can be placed. Imaging platform 516 may be movable or stationary. In one example, imaging platform includes a movable stage that allows subjects to be translated in a plane orthogonal to the light rays to allow the line of light to be translated across subject 102. Imaging platform 516 may also be configured to hold multiple subjects, such as multiple preclinical subjects, for simultaneous imaging of the subjects.

In one example, the fluorescence imaging may be combined with ultrasound imaging to simultaneously acquire fluorescence and ultrasound images of subject. In such an example, the imaging system may include one or more ultrasound transducers 518 to acquire the ultrasound images. In one example, the one or more ultrasound transducers 518 may be included in transillumination modules to generate 2D or 3D fluorescent images and photoacoustic (PA) images simultaneously.

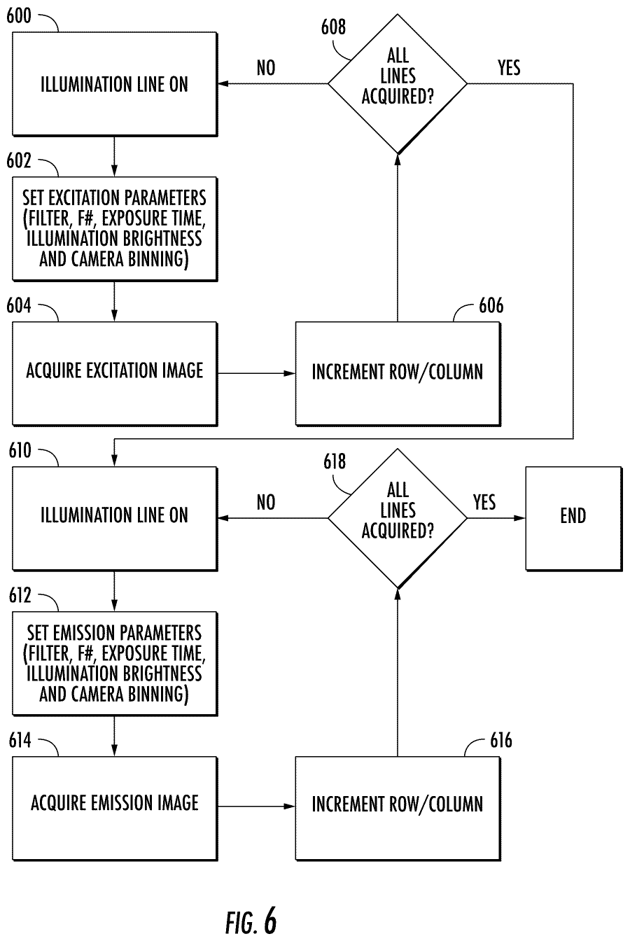

FIG. 6 is a flow chart illustrating an example of an image acquisition process that may be used to capture excitation and emission images of a subject having one or more fluorescence sources within the subject. Referring to FIG. 6, in step 600, an illumination line is turned on. For example, image acquisition controller 506 may activate one line of LEDs in an LED array being used as light source 100. In step 604, excitation parameters are set. In the illustrated example, the excitation parameters include the f-number, camera exposure time, illumination brightness, and camera binning. In step 604, an excitation image is acquired. In step 606, the row or column is incremented, and control proceeds to step 608 where it is determined whether all of the lines, i.e., rows and columns of the excitation image, have been acquired. If all of the lines have not been acquired, control proceeds to step 600 where the next illumination line is activated, and steps 602 through 608 are repeated until all of the lines of the excitation image have been acquired.

Once all of the lines of the excitation image have been acquired, control proceeds to step 610 where the process of acquiring the emission image begins. In step 610, an illumination line is activated. In step 612, emission parameters, such as filters, f-number, exposure time, illumination brightness, and camera binning are set to prevent detector saturation during the emission image capture. In step 614, the emission image for the particular line is acquired. In step 616, the row or column (counter) is incremented, and control proceeds to step 618 where it is determined whether all of the lines of the emission image have been acquired. If all the lines of the emission image have not been acquired, steps 610-618 are repeated. When all of the lines of the emission image have been acquired, the emission image, the excitation image, and image metadata for the emission and excitation images are passed to image reconstructor 508. The metadata that may be passed includes the f-number, image exposure time, binning, illumination brightness, neutral density filter factor (when a neutral density filter is used in the optical path), source position(s) in cm, i.e., where the light source is located in space relative to the subject, acquisition filter wavelengths (e.g., in nm), and spatially modulated corrections, i.e., corrections made in the images to correct for spherical lens aberrations and vignetting corrections.

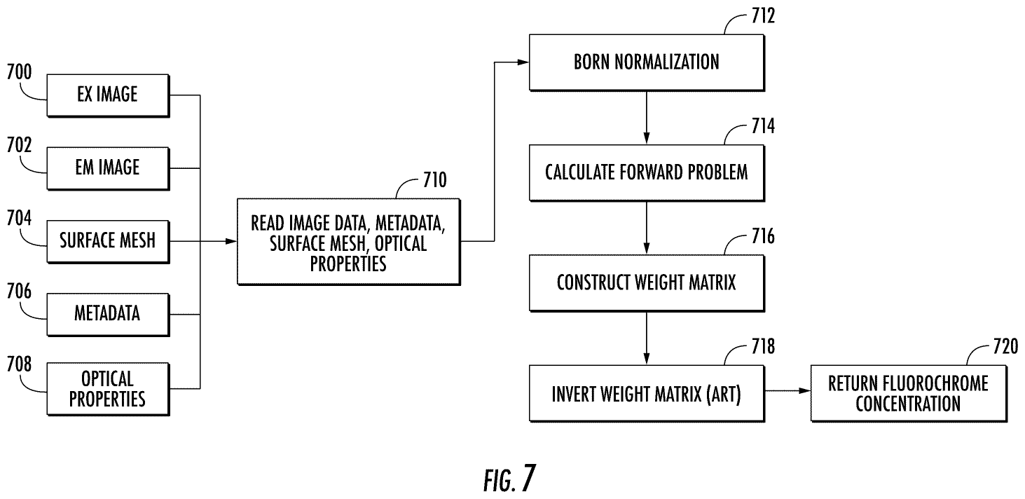

FIG. 7 is a flow chart illustrating an exemplary image reconstruction process that may be used to reconstruct an image of fluorophore concentration within a subject. Referring to FIG. 7, inputs to the image reconstruction process include an excitation image 700, an emission image 702, a surface mesh 704, image metadata 706, and optical properties 708. Excitation image 700 and emission image 702 are the excitation and emission images generated using the process illustrated in FIG. 6. Surface mesh 704 is a contour of the 3D surface of the subject represented by a set of surface vertices. The surface mesh may be captured optically using an image capture system capable of capturing image pixels and corresponding depths. Image metadata 706 is the metadata used to capture the excitation and emission images described above with respect to FIG. 6. Optical properties 708 include absorption and reduced scattering coefficients of the subject at the excitation and emission wavelengths.

In step 710, image reconstructor 508 reads the image data, the image metadata, the surface mesh, and the optical properties. In step 712, image reconstructor 508 performs Born normalization. Born normalization is the process of computing a Born approximation of a first order fluorescence response of the subject. In step 714, image reconstructor 508 computes the forward image reconstruction problem, which includes formulating the parameters of Equation 9 used to estimate the fluorophore concentrations of each voxel within a given subject based on the measurement inputs, locations of the light sources, the detector, and the volume boundary. In step 716, image reconstructor 508 computes the weight matrix of Equation 9. In step 718, image reconstructor 508 inverts the weight matrix. Inverting the weight matrix may be accomplished using any suitable inversion technique, such as ART, singular value decomposition (SVD) or Tikhonov regularization. Once the weight matrix is inverted, Equation 9 can be solved for the fluorophore concentration per voxel, which is returned in step 720.

As described above, light source 100 may be implemented using a transillumination module designed to illuminate a subject or specimen from one side, such as underneath the subject, and a detector may be positioned on the opposite side of the subject or specimen. FIG. 8 is a schematic diagram illustrating an exemplary transillumination module suitable for use as light source 100. Referring to FIG. 8, a transillumination module 800 includes an LED matrix 802, optical elements and anti-crosstalk layer 804, a cleanup filter layer 806, and a transparent waterproof layer 808. Cleanup filter 806 may be a short-pass optical filter or a band-pass optical filter LED matrix 802 may be a group of LEDs arranged in rows and columns similar to that illustrated schematically in FIG. 4. Optical elements and anti-crosstalk layer 804 may include any suitable structures for focusing the LED light and avoiding crosstalk between adjacent light emitting elements. Cleanup filter layer 806 may include one or more filters configured to pass light in the optical frequency bands of the LEDs in LED matrix 802 and block other frequencies. Transparent waterproof layer 808 may be formed of a suitable optically transparent and waterproof material, such as silicone.

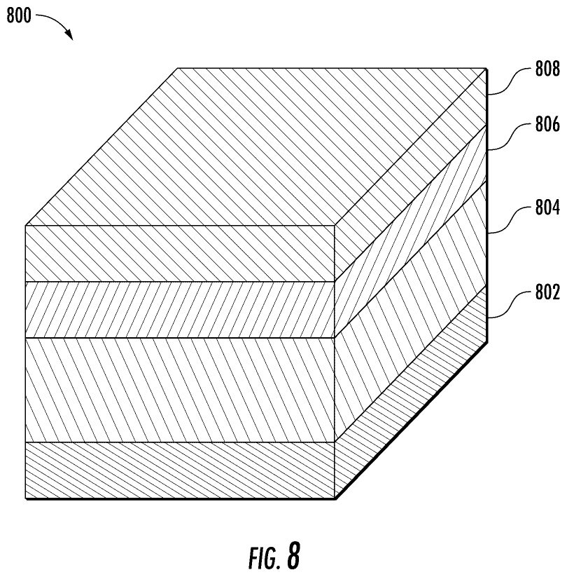

FIG. 9 illustrates an example of anti-crosstalk vanes that may be included in optical elements and anti-crosstalk layer 804 to reduce crosstalk between adjacent LEDs. Referring to FIG. 9, a portion of an anti-crosstalk grid 900 comprises a plurality of vanes 902 formed by walls 904 where vane 902 is configured to be located on top of an LED to guide the light emitted from the single LED. Walls 904 may be made of a material may be opaque and/or that causes total internal reflection at the operating frequency of the LEDs so that light from adjacent LEDs will not pass through walls 904 and can instead be guided from the inlet to the exit of each vane 902 without interfering with light from neighboring vanes 902. In an alternate example, vanes 902 can be replaced by tubes having a cylindrical cross section, as illustrated in FIG. 11.

FIG. 10 illustrates an example of a top view of anti-crosstalk grid 900. As illustrated in FIG. 10, anti-crosstalk grid 900 includes a plurality of light vanes 902 where one vane 902 is provided per LED.

FIG. 11 is a perspective view of a light pipe that may be included in each of the anti-crosstalk vanes of FIG. 9. In FIG. 11, a light pipe 1100 may be located in each vane 902 of grid 900 to further guide light as it travels through each vane 902 of grid 900. In one example, each light pipe 1100 may be formed of a clear acrylic or other optically translucent material. As indicated above, in one example, light pipe 1100 may be used without a vane. Such a light pipe may be constructed using a tube of optically reflective material, filling the tube with an optically transparent resin, curing the resin, and polishing the resin at the ends of the tube.

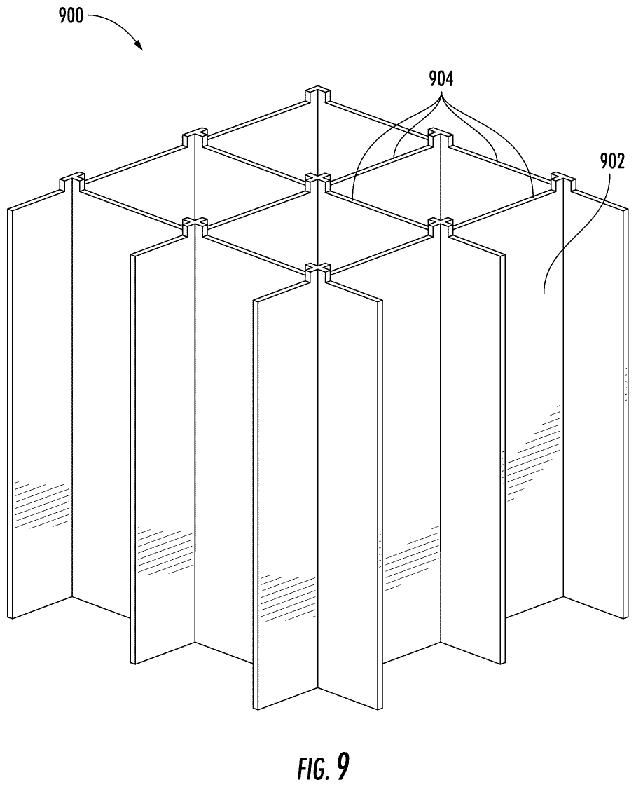

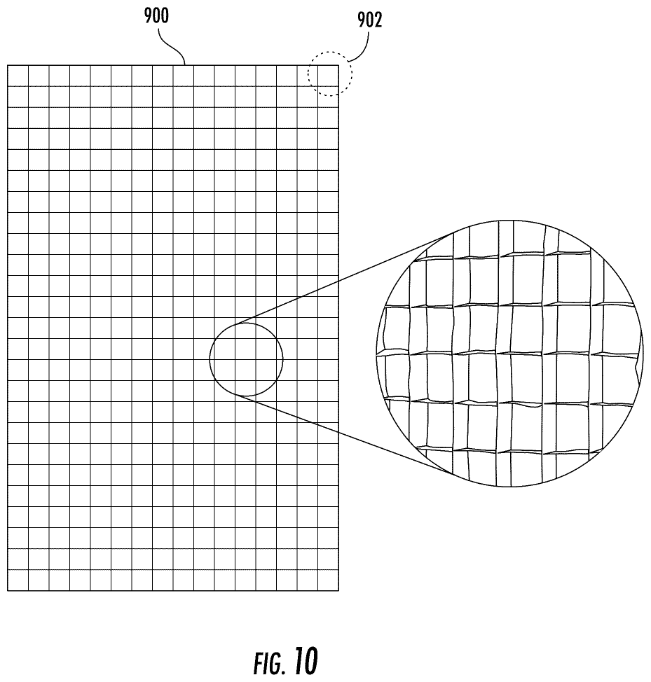

FIGS. 12A-12C illustrate examples of optical elements that may be included in optical elements and anti-crosstalk layer 804. In FIGS. 12A-12C, the optical elements include lenslet arrays 1200 of individual lenslets 1202 structured to focus light emitted by LEDs 1204 in LED matrix 802. In FIGS. 12A-12C one lenslet per LED is provided. Using lenslets 1202 between LEDs and the subject being illuminated allows separation between LED matrix 802 and the subject or specimen.

FIG. 13 is a schematic diagram of a cartesian motion stage suitable for moving imaging platform 516 or light source 100 in the system for fluorescence imaging tomography illustrated in FIG. 5. In FIG. 13, a movable stage 1300 comprises a substrate on which one or more imaging subjects may be placed or on which light source 100 may be mounted. Stage 1300 is movable in the x and y directions by a system of belts 1302 and 1304 and pulleys 1306 under the control of image acquisition controller 506 illustrated in FIG. 5. Image acquisition controller 506 may use the motion estimation equations illustrated in FIG. 13 to control and quantify the amount of motion of stage 1300.

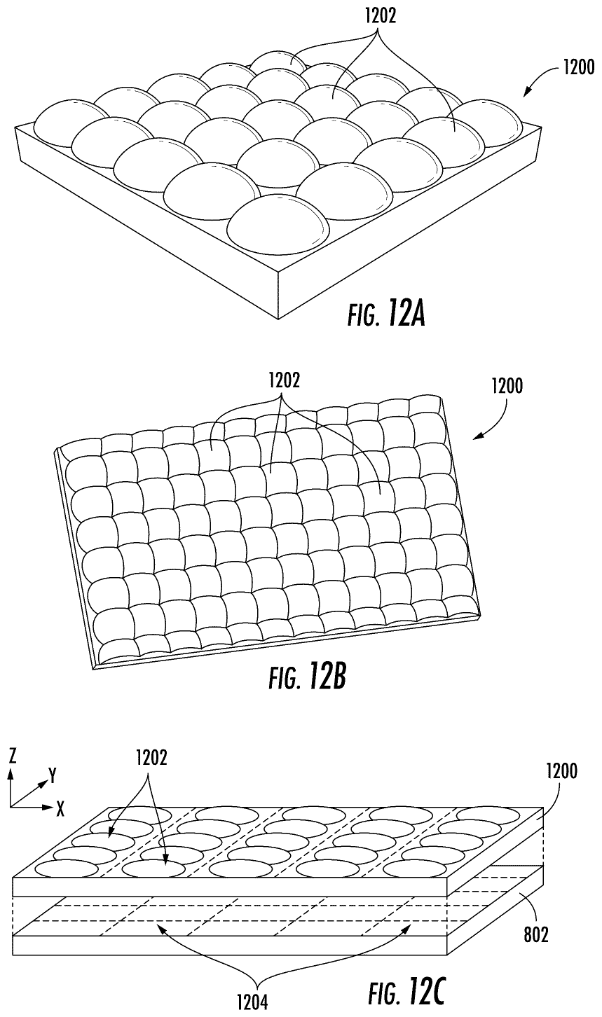

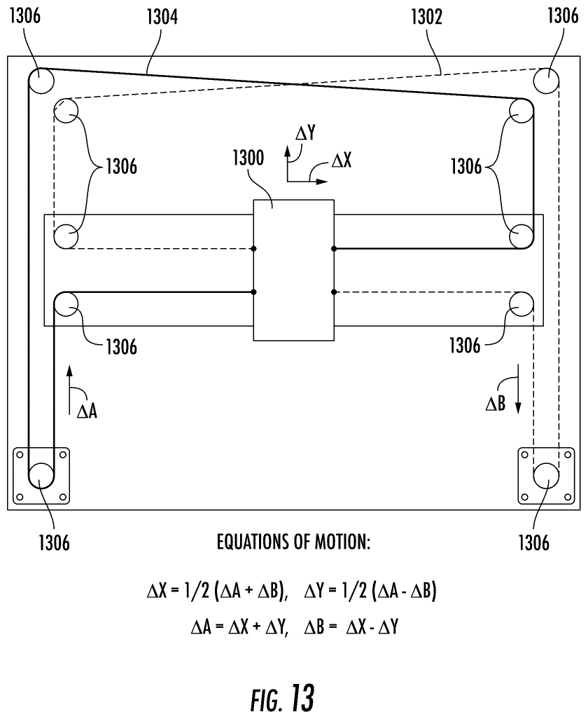

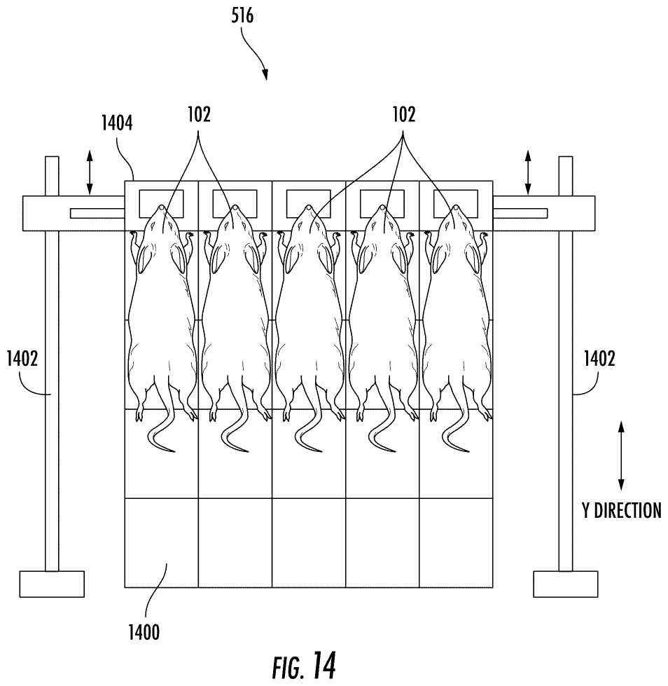

FIG. 14 is a schematic diagram of a multi-subject imaging platform suitable for use as the imaging platform in the system for fluorescence imaging tomography illustrated in FIG. 5. In FIG. 14, imaging platform 516 includes a substrate 1400 configured to hold a plurality of subjects 102 for simultaneous fluorescence imaging of subjects 102. In the illustrated example, substrate 1400 is configured to hold five subjects 102, which in the illustrated example are mice. Substrate 1400 is movably mounted to rails 1402 via bearings to allow substrate 1400 to move in the Y-direction, indicated by the double headed arrow in FIG. 14. An anesthesia manifold 1404 may be positioned near the end of substrate 1400 where the subject's heads are located during use to deliver gas to subjects 102 to anesthetize multiple subjects simultaneously.

FIG. 15 is a schematic diagram illustrating an array of transillumination modules suitable for use with the multi-subject platform illustrated in FIG. 14. In FIG. 15, the array includes a 2D matrix of transillumination modules 800A-800D where each row of the transillumination modules is configured to illuminate subjects 102 at different wavelengths. For example, transillumination modules 800A located in the first row may be configured to image subjects at red light wavelengths, transillumination modules 800B may be configured to image subjects 102 at infrared wavelengths, transillumination modules 800C may be configured to illuminate subjects 102 at yellow light wavelengths, and transillumination modules 800D may be configured to illuminate subjects 102 at green light wavelengths. It should be noted that the five columns of transillumination modules in the array in FIG. 15 allow simultaneous illumination of five subjects 102 at each wavelength.

In one example, a monochromatic or multi-chromatic LED module may be mounted on a cartesian translation stage (see FIG. 13) and immersed in non-conducting oil. The LED module may lie just under a transparent membrane. A specimen or subject is placed on the membrane “trampoline” in a water layer to allow ultrasound conduction. A multi-spectral camera is placed above the specimen or subject to record the fluorescence images. The LED module can operate in wavelengths tuned to specific fluorophore absorption bands. In one example, the LED module operates as a photoacoustic (PA) illuminator. For the PA application, the LED wavelength is in the near infrared (NIR) range ˜700 nm-980 nm. The LED illumination is pulsed to synchronize with the ultrasound data acquisition or using standard methods to measure pulse oxygenation.

In one example, two LED wavelengths are used in the same location to quantify tissue oxygenation. The two LED wavelengths may be selected to match the isosbestic point of hemoglobin. In one example, the wavelengths are equally spaced from the isosbestic point; i.e., λ1=λ0 +δλ and λ2=λ0−δλ, where λ0 is the isosbestic point, λ1 and λ2 are the two wavelengths, and δλ is the selected spacing of each wavelength from the isosbestic point. λ1 in one example is set to be about 20 nm, the isosbestic point is 800 nm, λ1 is 820 nm, and λ2 is 780 nm. In another example, the one wavelength is at the isosbestic point and the other is displaced in wavelength by δλ: λ1=λ0 and λ2=λ0+δλ.

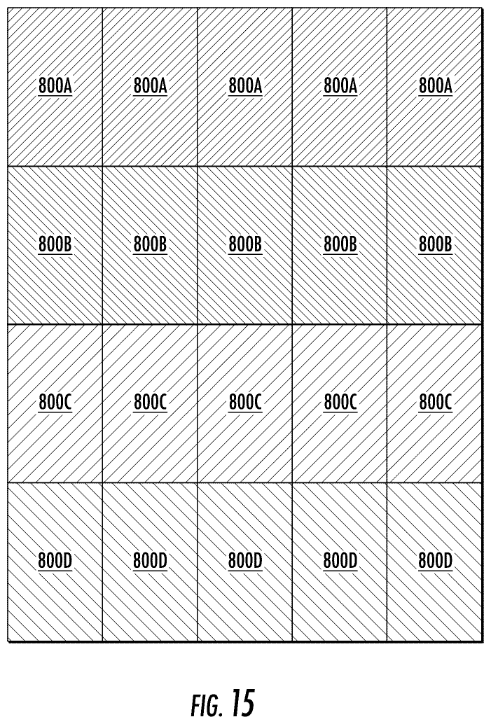

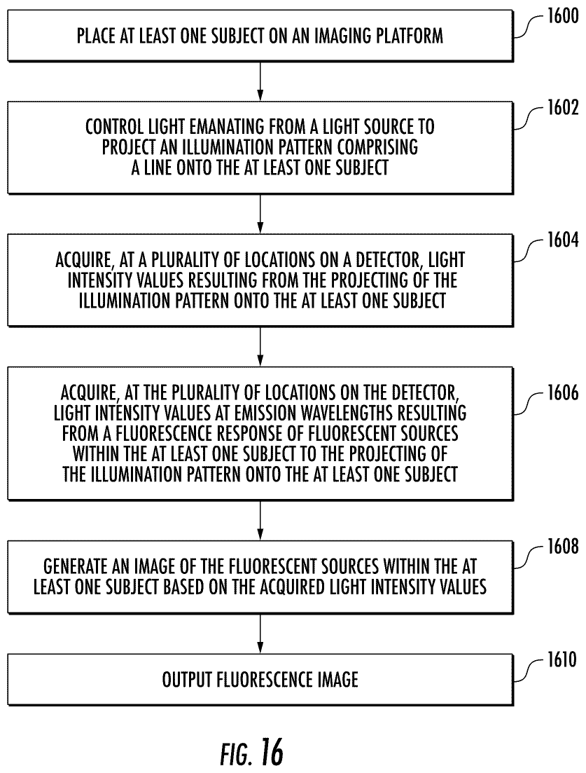

FIG. 16 is a flow chart illustrating exemplary overall steps of a process for fluorescence imaging tomography. Referring to FIG. 16, in step 1600, the process includes placing at least one subject on an imaging platform. For example, one or more subjects, such as pre-clinical subjects, including, but not limited to mice, may be placed on an imaging platform and anesthetized for the imaging procedure.

In step 1602, the process includes controlling light emanating from a light source to project an illumination pattern comprising at least one line onto the at least one subject. For example, the image acquisition controller may control a laser, an array of LEDs, a quasi-monochromatic or a filtered broadband light source to project one or more lines of light onto the imaging subject. The light source, the platform, both, or neither may move to scan the one or more lines of light across the subject. In one example, the line may be scanned across the subject in separate excitation capture and emission capture runs. If an array or matrix of LEDs is used to generate the illumination pattern, rows and columns of the LEDs may be sequentially activated to project lines of light at different locations across the subject. In one example, a laser may project a beam of light onto a rotating polygonal mirror, which produces a line of laser light. The line of laser light may be reflected onto the subject by first and second steering mirrors to produce first and second scan lines of laser light that are angularly offset from each other. The first and second steering mirrors may then tilt, i.e., rotate through an angle less than 90 degrees, about their respective axes to scan the first and second scan lines of laser light across the subject.

In step 1604, the process includes acquiring, at a plurality of locations on a detector, light intensity values at excitation wavelengths resulting from the projection of the illumination pattern onto the at least one subject. For example, during the excitation capture run, a filter may be placed between the detector and the light source so that the detector captures light at the excitation wavelengths. Individual detector sensing elements located at known locations on the detector may detect the light emitted by the light source for each projected column or row of light.

In step 1606, the process includes acquiring, at the plurality of locations on the detector, light intensity values at emission wavelengths resulting from a fluorescence response of fluorescent sources within the at least one subject to the projection of the illumination pattern onto the at least one subject. For example, during the emission capture run, a filter may be placed between the subject and the detector that allows light of wavelengths emitted by the fluorophore being imaged to pass while rejecting other wavelengths. Individual detector sensing elements located at known locations on the detector may detect the light emitted by the fluorophore for each projected column or row of light.

In step 1608, the process includes generating an image of the fluorescent sources within the at least one subject based on the acquired light intensity values. For example, image reconstructor 508 may compute the weight matrix of Equation 9, invert the weight matrix, and solve an equation, such as Equation 9, to determine the fluorophore intensities and locations in the subject.

In step 1610, the process includes outputting the image. For example, image reconstructor 508 may output a 2D or 3D image of fluorophore intensities and locations. FIG. 17 is an example of 2D reconstructed image slices generated using the reconstruction method described herein for a pair of simulated fluorophores within a simulated subject. The 2D image slices illustrated in FIG. 17 can be combined to generate a 3D image of the fluorophores within the subject.

FIGS. 18A-18C illustrate another example of an anti-crosstalk grid that may be used in an anti-crosstalk and optical elements layer of the transillumination module of FIG. 8. More particularly, 18A is a top view of an anti-crosstalk grid 1800, FIG. 18B is a sectional view of anti-crosstalk grid 1800 taken through line A-A in FIG. 18A, and FIG. 18C is a perspective view of anti-crosstalk grid 1800. Anti-crosstalk grid 1800 is a rectangular slab that includes a plurality of apertures 1802. Each aperture 1802 may be placed over a light-emitting element in LED matrix 802 to allow light from the light emitting elements to propagate through apertures 1802. The surfaces of anti-crosstalk grid 1802 that form apertures 1802 may include light reflective or absorptive materials. Apertures 1802 may be filled with an optically transmissive polymer, optical fibers, or lenses. The material used for anti-crosstalk grid 1800 can be carbon fiber for low x-ray absorption or scattering, aluminum, or a polymer.

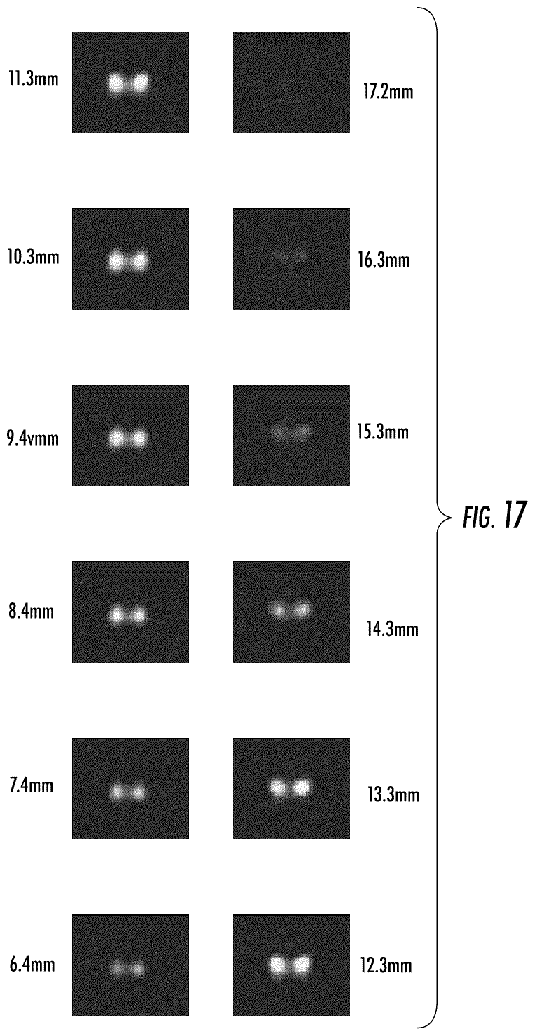

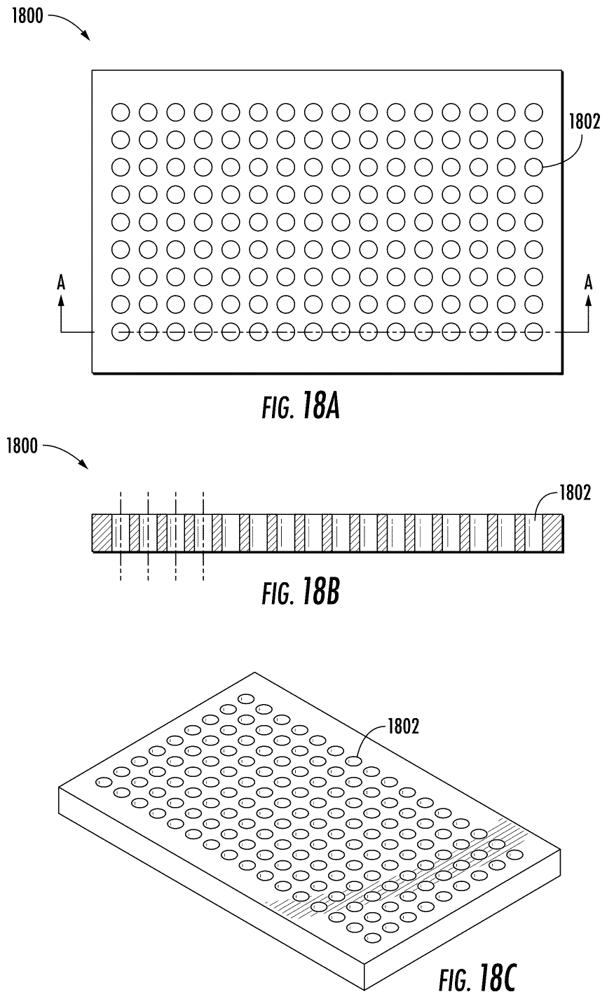

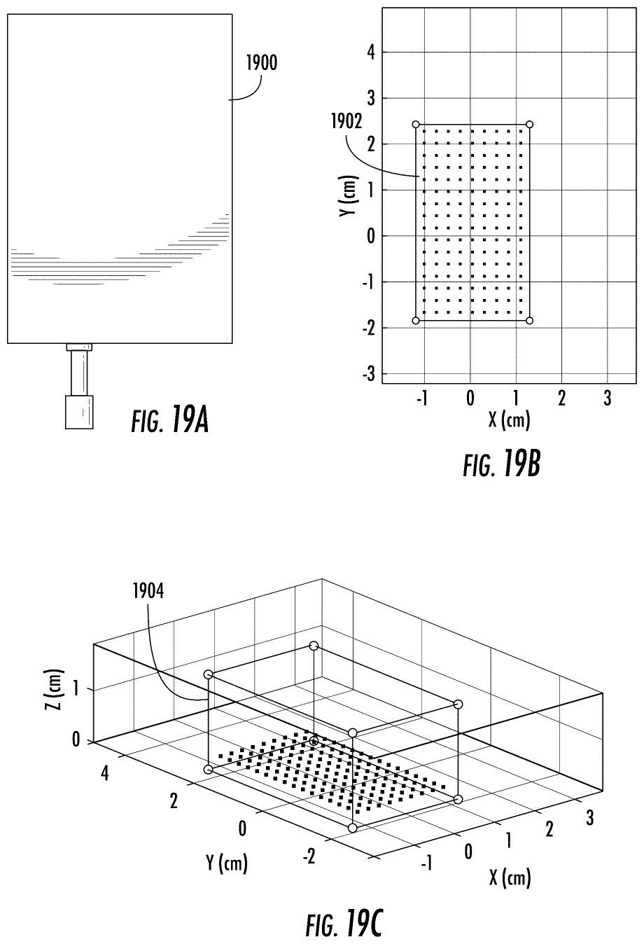

FIGS. 19A-19C illustrate an experimental setup for using linear illumination patterns to illuminate fluorophores within a subject. In FIG. 19A, the experimental setup includes a tissue mimicking phantom 1900. Tissue mimicking phantom includes a fluorophore embedded near the lower left corner. FIG. 19B is a schematic diagram of an LED array 1902 used to image tissue mimicking phantom 1900. FIG. 19C illustrates a bounding box 1904 used for image reconstruction.

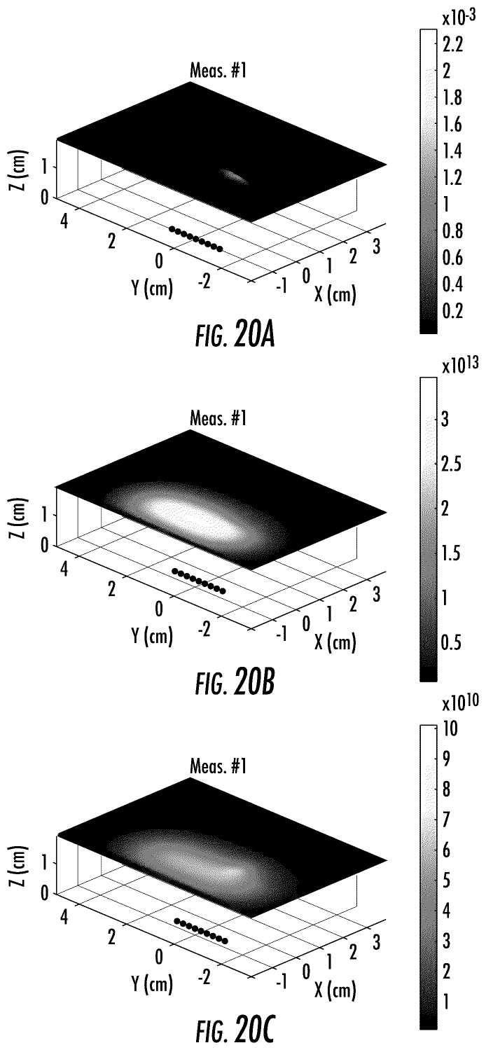

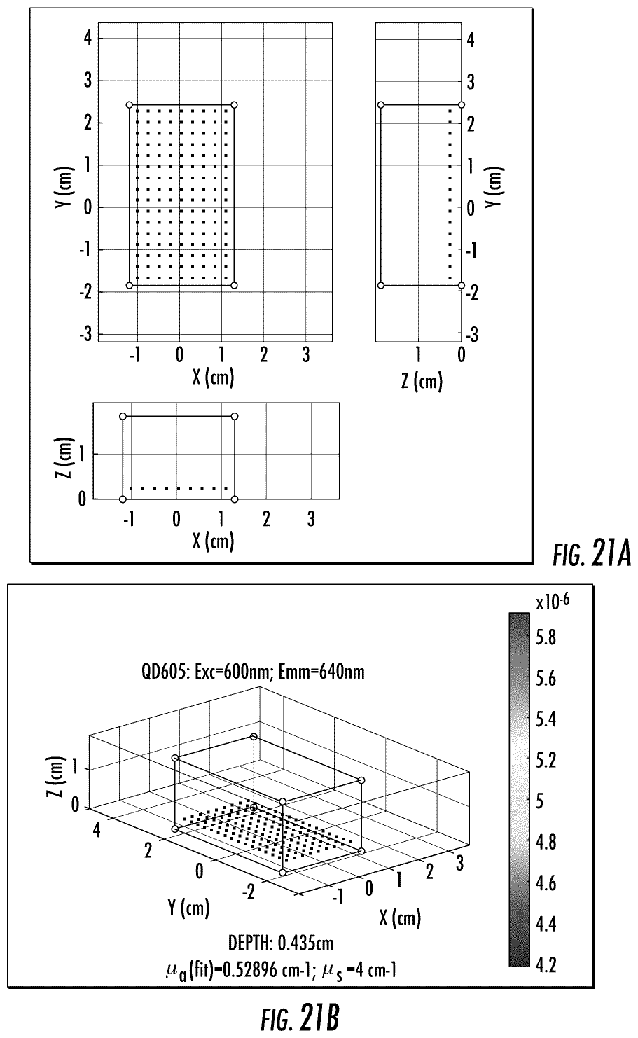

FIGS. 20A-20C respectively illustrate normalized data, excitation data, and emission data from scanning lines of light created by an LED array across a tissue mimicking phantom. Using a line of light versus raster scanning of a point light source reduces the number of scans to 25 from 90 if the point line sources in LED array 1902 are scanned individually.

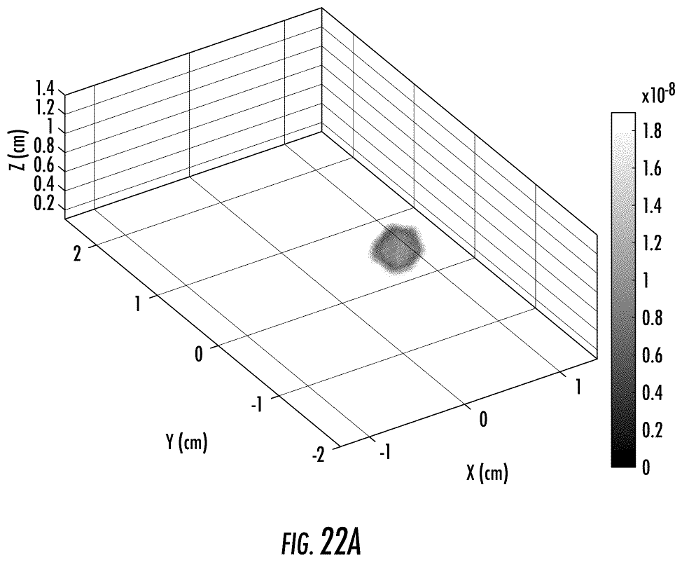

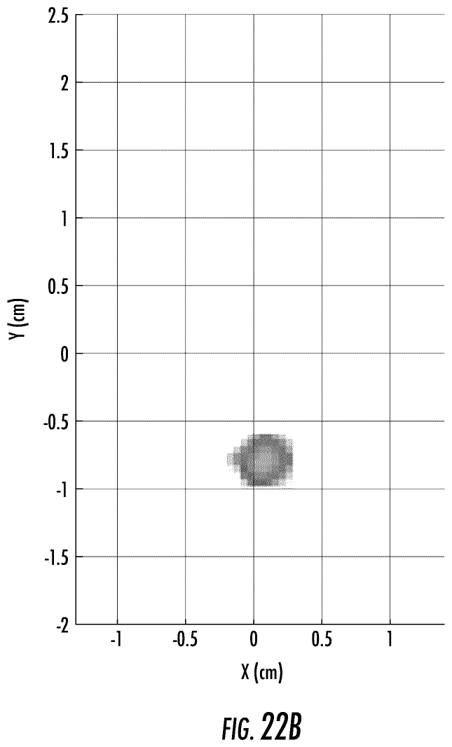

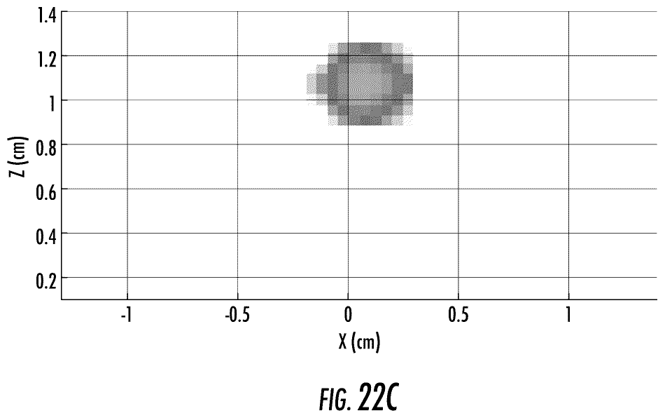

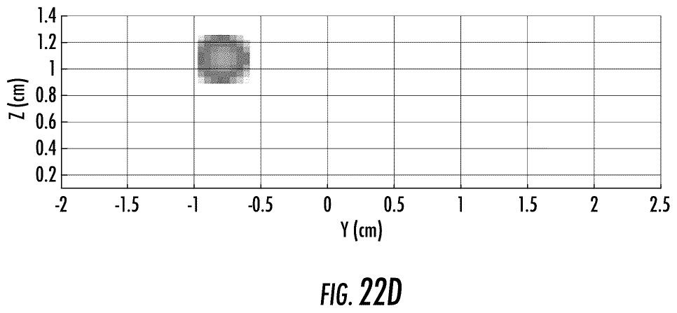

FIGS. 21A and 21B illustrate a schematic of the LED matrix for the experimental results illustrated in FIGS. 22A-22D. More particularly, FIG. 21 illustrates the LED matrix and the phantom-mimicking slab in the X-Y, Y-Z, and X-Z planes. FIG. 21B is a 3D view of the phantom-mimicking slab and the LED matrix.

FIGS. 22A-22D illustrate renderings of a fluorophore located in the phantom-mimicking slab. FIG. 22A is a 3D rendering of the spatial distribution of fluorophore concentration inside the phantom-mimicking slab, with intensity increasing from black (zero) to white (maximum). FIG. 21B shows the X-Y view from the top. FIG. 22C shows the X-Z image from the front. FIG. 22D shows the Y-Z image from the side of the phantom. The phantom height is 1.5 cm.

The present technology has been described herein with reference to the accompanying drawings, in which illustrative embodiments of the technology are shown. In the drawings, the relative sizes of regions or features may be exaggerated for clarity. This technology may, however, be embodied in many different forms and should not be construed as limited to the embodiments set forth herein; rather, these embodiments are provided so that this disclosure will be thorough and complete, and will fully convey the scope of the technology to those skilled in the art.

It will be understood that, although the terms first, second, etc., may be used herein to describe various elements, components, regions, layers and/or sections, these elements, components, regions, layers, and/or sections should not be limited by these terms. These terms are only used to distinguish one element, component, region, layer or section from another region, layer, or section. Thus, a first element, component, region, layer, or section discussed below could be termed a second element, component, region, layer, or section without departing from the teachings of the present technology.

Spatially relative terms, such as “beneath”, “below”, “lower”, “above”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90° or at other orientations) and the spatially relative descriptors used herein interpreted accordingly.

As used herein, the singular forms “a”, “an” and “the” are intended to include the plural forms as well, unless expressly stated otherwise. It will be further understood that the terms “includes,” “comprises,” “including” and/or “comprising,” when used in this specification, specify the presence of stated features, integers, steps, operations, elements, and/or components, but do not preclude the presence or addition of one or more other features, integers, steps, operations, elements, components, and/or groups thereof. It will be understood that when an element is referred to as being “connected” or “coupled” to another element, it can be directly connected or coupled to the other element or intervening elements may be present. As used herein, the term “and/or” includes any and all combinations of one or more of the associated listed items.

The term “programmatically” refers to operations directed and/or primarily carried out electronically by computer program modules, code and/or instructions. The term “electronically” includes both wireless and wired connections between components.

It will be understood that various details of the subject matter described herein may be changed without departing from the scope of the subject matter described herein. Furthermore, the foregoing description is for the purpose of illustration only, and not for the purpose of limitation, as the subject matter described herein is defined by the claims as set forth hereinafter. The following claims, therefore, are to be read to include not only the combination of elements which are literally set forth but all equivalent elements for performing substantially the same function in substantially the same way to obtain substantially the same result. The claims are thus to be understood to include what is specifically illustrated and described above, what is conceptually equivalent, and also what incorporates the essential idea of the invention.

What is claimed is:

1. A method for fluorescence imaging tomography, the method comprising:
placing at least one subject on an imaging platform;
controlling light emanating from a light source to project an illumination pattern comprising at least one line onto the at least one subject;
acquiring, at a plurality of locations on a detector, light intensity values at excitation wavelengths resulting from the projecting of the illumination pattern onto the at least one subject;
acquiring, at the plurality of locations on the detector, light intensity values at emission wavelengths resulting from a fluorescence response of fluorescent sources within the at least one subject to the projecting of the illumination pattern onto the at least one subject;
generating an image of the fluorescent sources within the at least one subject based on the acquired light intensity values; and
outputting the image.

2. The method of claim 1 wherein controlling the light emanating from the source to project the illumination pattern onto the at least one subject includes controlling the light source to project the illumination pattern onto the at least one subject for illuminating the at least one subject from a first side of the at least one subject and acquiring the light intensity values at the excitation and emission wavelengths includes acquiring the light intensity values at the excitation and emission wavelengths from the detector located on a second side of the at least one subject opposite the first side.

3. The method of claim 2 wherein the detector comprises a camera.

4. The method of claim 1 wherein controlling the light emanating from the light source to project the illumination pattern includes controlling a plurality of light emitting diodes (LEDs) arranged in a linear pattern to be simultaneously ON.

5. The method of claim 4 wherein the LEDs are located in a transillumination module configured to hold the LEDs in proximity to the at least one subject.

6. The method of claim 4 wherein controlling the light emanating from light source to project the illumination pattern onto the at least one subject includes sequentially exciting successive rows and columns of the LEDs in an LED matrix.

7. The method of claim 1 wherein controlling the light emanating from light source to project the illumination pattern includes controlling a laser and one or more mirrors to generate first and second scan lines of laser light that are angularly offset from each other.

8. The method of claim 7 wherein controlling the laser and the one or more mirrors to generate the first and second scan lines of laser light includes rotating a polygonal mirror to produce a line of laser light, reflecting the line of laser light onto the subject using a first steering mirror to produce the first scan line of laser light, reflecting the line of laser light onto the subject using a second steering mirror to produce the second scan line of laser light, and scanning the first and second scan lines of laser light across the subject by tilting the first and second steering mirrors.

9. The method of claim 1 wherein controlling the light emanating from the light source includes controlling a two-axis galvanometer to reflect, onto the at least one subject, first and second scan lines of light that are angularly offset from each other.

10. The method of claim 1 wherein controlling the light source to project the illumination pattern includes controlling a quasi-monochromatic light source to project the illumination pattern.

11. The method of claim 1 wherein the at least one subject comprises at least one preclinical subject.

12. The method of claim 1 wherein the at least one subject comprises a plurality of preclinical subjects simultaneously positioned on the imaging platform and wherein acquiring the light intensity values at the emission wavelengths includes simultaneously acquiring the light intensity values for light emitted from the plurality of preclinical subjects.

13. The method of claim 1 wherein generating the image includes generating a two-or three-dimensional image of the fluorescent sources within the at least one subject.

14. The method of claim 1 wherein generating the image of the fluorescent sources includes constructing a weight matrix from the light intensity values at the excitation and emission wavelengths, inverting the weight matrix, and solving an equation for a concentration of the fluorescent sources within the at least one subject.

15. The method of claim 1 comprising acquiring at least two ultrasound images of the at least one subject simultaneously with the acquiring of the light intensity values at at least two emission wavelengths.

16. The method of claim 1 comprising using a spatial illumination mask to limit light emitted by the light source to a region occupied by the subject.

17. The method of claim 1 wherein generating the image of the fluorescent sources includes:
modeling excitation intensity at a point within the at least one subject resulting from the illumination pattern comprising at least one line using a Hankel function of the first kind;
modeling emission intensity at a point on the detector as an integral over a volume occupied by the at least one subject of a product of the modeled excitation intensity, concentration of the fluorescence sources within the at least one subject, and Green's function at a fluorophore emission wavelength from a point within the at least one subject to the detector; and
reconstructing normalized measurements of fluorescence intensity at a detector location given the acquired light intensity values and using the modeled emission and excitation intensities.

18. A system for fluorescence imaging tomography, the system comprising:
an imaging platform for holding at least one subject to be imaged;
a light source for projecting an illumination pattern comprising at least one line onto the at least one subject;
a detector for detecting light at excitation wavelengths produced by the light source and at emission wavelengths produced by fluorescent sources within the at least one subject;
an image acquisition controller for controlling light emanating from the light source to project the illumination pattern onto the at least one subject; and
an image reconstructor for generating an image of the fluorescent sources within the at least one subject based on the acquired light intensity values and outputting the image.

19. The system of claim 18 wherein the image acquisition controller is configured to control the light source to project the illumination pattern onto the at least one subject for illuminating the at least one subject from a first side of the at least one subject and the detector is configured to acquire the light intensity values at the excitation and emission wavelengths a second side of the at least one subject opposite the first side.

20. The system of claim 18 wherein the detector comprises a camera.

21. The system of claim 18 wherein the light source comprises a plurality of LEDs arranged in a linear pattern, and the image acquisition controller is configured to control the LEDs in the linear pattern to be simultaneously ON.

22. The system of claim 21 comprising a transillumination module configured to hold the LEDs in proximity to the at least one subject.

23. The system of claim 21 wherein the image acquisition controller is configured to control the light emanating from the light source to project the illumination pattern onto the at least one subject by sequentially exciting successive rows and columns of the LEDs in an LED matrix.

24. The system of claim 18 comprising a plurality of mirrors, wherein the light source comprises a laser and the image acquisition controller is configured to control the laser to project laser light onto a first mirror of the plurality of mirrors, rotate the first mirror to produce a line of laser light, and reflect the line of laser light using first and second steering mirrors to produce first and second scan lines of laser light on the at least one subject and that are angularly offset from each other.

25. The system of claim 24 wherein the image acquisition controller is configured to control tilting of the first and second steering mirrors to scan the first and second scan lines of laser light across the at least one subject.

26. The system of claim 18 comprising a two-axis galvanometer wherein the image acquisition controller is configured to control the light emanating from the light source by controlling the two-axis galvanometer to reflect, onto the at least one subject, first and second scan lines of light that are angularly offset from each other.

27. The system of claim 18 wherein the light source comprises a quasi- monochromatic light source for projecting the illumination pattern.

28. The system of claim 18 wherein the at least one subject comprises at least one preclinical subject.

29. The system of claim 18 wherein the imaging platform is configured to hold a plurality of preclinical subjects, and the image acquisition controller is configured to simultaneously acquire the light intensity values at the light emission wavelengths for light emitted from the plurality of preclinical subjects.

30. The system of claim 18 wherein the image reconstructor is configured to generate a two-or three-dimensional image of the fluorescent sources within the at least one subject.

31. The system of claim 18 wherein the image reconstructor is configured to generate the image of the fluorescent sources by constructing a weight matrix from the light intensity values at the excitation and emission wavelengths, inverting the weight matrix, and solving an equation for a concentration of the fluorescent sources within the at least one subject.

32. The system of claim 18 comprising an ultrasound transducer for acquiring at least two ultrasound images of the at least one subject simultaneously with the acquiring of the light intensity values at at least two emission wavelengths.

33. The system of claim 18 comprising at least one bandpass or short-pass excitation filter for filtering light emanating from the light source.

34. The system of claim 18 comprising a spatial illumination mask configured to limit light emitted by the light source to a region occupied by the subject.

35. The system of claim 18 comprising at least one emission filter for filtering light emitted from the subject.

36. The system of claim 18 wherein the light source includes a plurality of light emitting elements and the system includes an anti-crosstalk grid positioned on a light emitting side of the light emitting elements for reducing crosstalk between adjacent light emitting elements.

37. The system of claim 18 comprising a light pipe or focusing optics positioned on a light emitting side of the light source.
